(19) United States
(12) Patent Application Publication
(10) Pub. No.: US 2026/0338537 A1
(43) Pub. Date: Oct. 29, 2026

(54) SIMULATED EYEBALL APPARATUS

(71) Applicant: YONGJIANG LABORATORY, Ningbo (CN)

(72) Inventors: Lei ZHAO, Ningbo (CN); Shunli ZANG, Ningbo (CN); Xiaochen ZHOU, Ningbo (CN); Guanghang MEI, Ningbo (CN); Tao HE, Ningbo (CN); Zhengyu WANG, Ningbo (CN); Chaohao WANG, Ningbo (CN)

(21) Appl. No.: 19/692,953

(22) Filed: May 29, 2026

Related U.S. Application Data
(63) Continuation-in-part of application No. PCT/CN2024/121565, filed on Sep. 26, 2024.
(63) Continuation-in-part of application No. PCT/CN2024/121551, filed on Sep. 26, 2024.

(30) Foreign Application Priority Data
Nov. 30, 2023 (CN) 202311632103.5
Nov. 30, 2023 (CN) 202311632205.7

(51) Int. Cl. G01B 11/00

(52) U.S. Cl. CPC G01B 11/002

(57) ABSTRACT

A simulated eyeball apparatus includes: a first rotating assembly connected to a simulated eyeball; and a second rotating assembly connected to the simulated eyeball and the first rotating assembly. A rotation axis of the first rotating assembly and a rotation axis of the second rotating assembly are non-parallel and lie in two non-parallel planes, to ensure that, when the simulated eyeball apparatus tracks a target point, based on position information of the simulated eyeball and position information of the target point, the first rotating assembly drives the simulated eyeball to rotate to adjust a pitch angle of the simulated eyeball and the second rotating assembly drives the simulated eyeball and the first rotating assembly to rotate synchronously to adjust a horizontal azimuth angle of the simulated eyeball.

### CROSS-REFERENCE TO RELATED APPLICATIONS

This application is a continuation-in-part of, and claims the benefit to, International Application PCT/CN2024/121565 filed on Sep. 26, 2024, which claims a priority to Chinese Patent Application No. 202311632205.7, titled “EYE MOVEMENT TRACKING DEVICE” and filed on Nov. 30, 2023. This application is also a continuation-in-part of, and claims the benefit to, International Application PCT/CN2024/121551 filed on Sep. 26, 2024, which claims a priority to Chinese Patent Application No. 202311632103.5, titled “EYE SIMULATION DEVICE” and filed on Nov. 30, 2023. The entire contents of the above-referenced patent applications are incorporated herein by reference.

### TECHNICAL FIELD

The present disclosure relates to the field of visual equipment technologies, and more particularly, to a simulated eyeball apparatus, a test apparatus, and an eye movement tracking method.

### BACKGROUND

With the rapid development of optical instruments, intelligent robots and other fields, a demand for devices capable of simulating eye movement is growing increasingly. Such devices for simulating the eye movement can be used for quality inspection of an optical instrument such as an eye tracker and an ophthalmic optical biometer, and can also be applied as a component of an intelligent robot.

### SUMMARY

The present disclosure aims to solve at least one of the technical problems in the related art. To this end, the present disclosure provides a simulated eyeball apparatus, a test apparatus, and an eye movement tracking method.

In a first aspect, the present disclosure provides a simulated eyeball apparatus. The simulated eyeball apparatus includes: a simulated eyeball; a first rotating assembly connected to the simulated eyeball; and a second rotating assembly connected to the simulated eyeball and the first rotating assembly, where a rotation axis of the first rotating assembly and a rotation axis of the second rotating assembly are non-parallel and lie in two non-parallel planes, to ensure that, through cooperation of the first rotating assembly and the second rotating assembly, when the simulated eyeball apparatus tracks a target point, based on position information of the simulated eyeball and position information of the target point, the first rotating assembly drives the simulated eyeball to rotate to adjust a pitch angle of the simulated eyeball, and the second rotating assembly drives the simulated eyeball and the first rotating assembly to rotate synchronously to adjust a horizontal azimuth angle of the simulated eyeball, achieving three-dimensional spatial rotation of the simulated eyeball driven by the two axes.

Additional aspects and advantages of the present disclosure will be provided in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a first schematic structural view of a simulated eyeball apparatus according to an embodiment of the present disclosure.

FIG. 2 is a top view of a simulated eyeball apparatus according to an embodiment of the present disclosure.

FIG. 3 is a partial schematic view of a simulated eyeball apparatus according to an embodiment of the present 1disclosure.

FIG. 4 is a second schematic structural view of a simulated eyeball apparatus according to an embodiment of the present disclosure.

FIG. 5 is a first schematic view of gazing of a simulated eyeball of a simulated eyeball apparatus at a target point according to an embodiment of the present disclosure.

FIG. 6 is a second schematic view of gazing of a simulated eyeball of a simulated eyeball apparatus at a target point according to an embodiment of the present disclosure.

FIG. 7 is a first schematic flowchart of an eye movement tracking control method according to an embodiment of the present disclosure.

FIG. 8 is a first schematic view of a deflection generated by rotation of a simulated eyeball according to an embodiment of the present disclosure.

FIG. 9 is a second schematic view of a deflection generated by rotation of a simulated eyeball according to an embodiment of the present disclosure.

FIG. 10 is a second schematic flowchart of an eye movement tracking control method according to an embodiment of the present disclosure.

FIG. 11 is a third schematic flowchart of an eye movement tracking control method according to an embodiment of the present disclosure.

FIG. 12 is a schematic structural view of an eye movement tracking control apparatus according to an embodiment of the present disclosure.

FIG. 13 is a first schematic structural view of a simulated eyeball apparatus according to an embodiment of the present disclosure.

FIG. 14 is a second schematic structural view of a simulated eyeball apparatus according to an embodiment of the present disclosure.

FIG. 15 is a schematic structural view of a simulated eyeball according to an embodiment of the present disclosure.

FIG. 16 is a schematic structural view of a simulated eyeball fixing frame according to an embodiment of the present disclosure.

FIG. 17 is a third schematic structural view of a simulated eyeball apparatus according to an embodiment of the present disclosure.

FIG. 18 is a schematic flowchart of an eye movement tracking method according to an embodiment of the present disclosure.

FIG. 19 is a schematic structural view of an electronic device according to an embodiment of the present disclosure.

FIG. 20 is a schematic structural view of a test apparatus according to an embodiment of the present disclosure.

Reference numerals of the accompanying drawings:
simulated eyeball 100, spherical structure 110, corneo-lenticular bulge 102, artificial iris decal 120, first support 210, first fixing plate 211, second fixing plate 212, first rotating assembly 230, second rotating assembly 240, eyeball base 260, linear sliding table 270, display screen 300;
simulated eyeball fixing frame 310, first fixing frame body 311, second fixing frame

body 320, limit structure 320, rotary stage 410, rotary stage connection plate 420;

connection rod 510, goniometric stage 520, goniometric stage fixing plate 521, goniometric stage lifting connection plate 522, second support 610.

### DETAILED DESCRIPTION

Technical solutions according to embodiments of the present disclosure will be described clearly below in combination with accompanying drawings of the embodiments of the present disclosure. Obviously, the embodiments described are only a part of the embodiments of the present disclosure, rather than all the embodiments of the present disclosure. On a basis of the embodiments of the present disclosure, all other embodiments obtained by those skilled in the art shall fall within the protection scope of the present disclosure.

Terms “first” and “second” in the specification and claims of the present disclosure are used to distinguish similar objects, rather than to describe a specific sequence or order. It should be understood that data as used can be interchanged where appropriate, to enable the embodiments of the present disclosure described herein to be implemented in an order other than that illustrated or described herein. Also, the objects distinguished by the terms such as “first” and “second” are usually objects of the same type. The quantity of the objects is not limited. For example, one or a plurality of first objects may be provided. In addition, “and/or” throughout the specification and appended claims indicates at least one of the objects associated with “and/or”. The character “/” generally indicates that the associated objects before and after the character are in an “or” relationship.

At present, the devices for simulating the eye movement differ greatly from real human eyes, with low motion control accuracy and poor simulation accuracy for the multi-dimensional complex movement of human eyes.

The present disclosure provides a simulated eyeball apparatus, a test apparatus, and an eye movement tracking method, which can accurately simulate multi-dimensional complex movement of human eyes, and effectively improve motion control accuracy of the simulated eyeball.

A simulated eyeball apparatus, a test apparatus, an eye movement tracking control method, an eye movement tracking control apparatus, an eye movement tracking method, an electronic device, and a readable storage medium provided in the embodiments of the present disclosure will be described in detail below in conjunction with the accompanying drawings through specific embodiments and application scenarios.

The simulated eyeball apparatus in the embodiments of the present disclosure is a mechanical device for simulating human eye rotation, and can be applied to multiple fields such as eye movement device testing, eye disease diagnosis and treatment, visual function evaluation, and human-computer interaction.

The embodiments of the present disclosure provide a simulated eyeball apparatus including a simulated eyeball 100, a first rotating assembly 230, and a second rotating assembly 240.

The first rotating assembly 230 is connected to the simulated eyeball 100. The second rotating assembly 240 is connected to the simulated eyeball 100 and the first rotating assembly 230. A rotation axis of the first rotating assembly 230 and a rotation axis of the second rotating assembly 240 are non-parallel and lie in two non-parallel planes, to ensure that, through cooperation of the first rotating assembly 230 and the second rotating assembly 240, when the simulated eyeball apparatus tracks a target point, based on position information of the simulated eyeball 100 and position information of the target point, the first rotating assembly 230 drives the simulated eyeball 100 to rotate to adjust a pitch angle of the simulated eyeball 100, and the second rotating assembly 240 drives the simulated eyeball 100 and the first rotating assembly 230 to rotate synchronously to adjust a horizontal azimuth angle of the simulated eyeball 100, achieving three-dimensional spatial rotation of the simulated eyeball driven by the two axes.

In some embodiments, an axial extension line of the first rotating assembly 230 and an axial extension line of the second rotating assembly 240 intersect at an eyeball center of the simulated eyeball 100 (i.e., a spherical structure center point of the simulated eyeball 100).

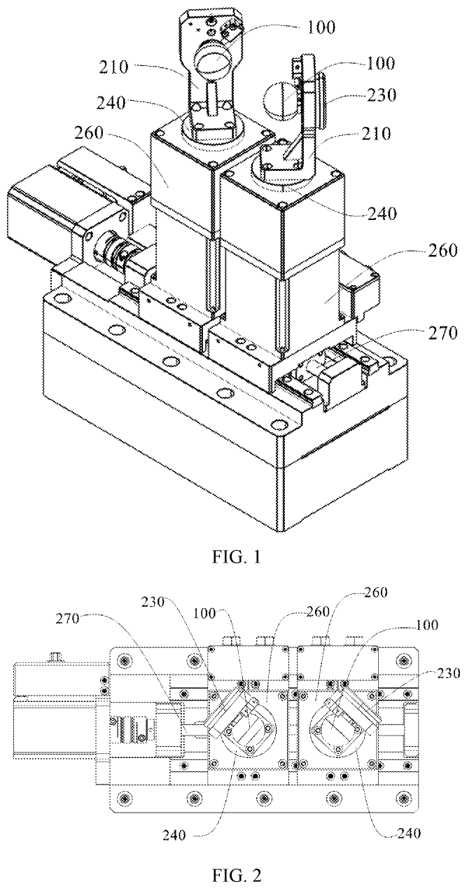

In an embodiment illustrated in FIG. 1, a first angle is formed between a line connecting a pupil and the eyeball center of the simulated eyeball 100 and an axial direction of the first rotating assembly 230. Through cooperation of the first rotating assembly 230, the second rotating assembly 240, and the first angle, when the simulated eyeball apparatus tracks the target point, based on the position information of the simulated eyeball 100 and the position information of the target point, the first rotating assembly 230 drives the simulated eyeball 100 to rotate to adjust the pitch angle of the simulated eyeball 100, and the second rotating assembly 240 drives the simulated eyeball 100 and the first rotating assembly 230 to rotate synchronously to adjust the horizontal azimuth angle of the simulated eyeball 100, achieving the three-dimensional spatial rotation of the simulated eyeball driven by the two axes.

The first rotating assembly 230 is configured to drive the simulated eyeball 100 to move about the axial direction of the first rotating assembly 230, to adjust the pitch angle of the simulated eyeball 100.

The pitch angle refers to an angular change of a gazing direction of the simulated eyeball 100 in a vertical direction, corresponding to upward or downward eyeball movement of the human eyes. The second rotating assembly 240 is connected to the simulated eyeball 100 and the first rotating assembly 230. The second rotating assembly 240 is configured to drive the simulated eyeball 100 and the first rotating assembly 230 to move about an axial direction of the second rotating assembly 230, to adjust the horizontal azimuth angle of the simulated eyeball 100.

In this embodiment, the first rotating assembly 230 is configured to adjust the pitch angle of the simulated eyeball 100, and the second rotating assembly 240 is configured to adjust the horizontal azimuth angle of the simulated eyeball 100. The rotation axis of the first rotating assembly 230 and the rotation axis of the second rotating assembly 240 lie in the two non-parallel planes, and omnidirectional rotation of the simulated eyeball 100 can be realized by means of the first rotating assembly 230 and the second rotating assembly 240.

It should be noted that a gaze direction of the simulated eyeball 100 is a direction of the line connecting the pupil and the eyeball center of the simulated eyeball 100. The first angle is formed between the line connecting the pupil and the eyeball center of the simulated eyeball 100 and the axial direction of the first rotating assembly 230 (the first angle is not 0° or 180°). When the first rotating assembly 230 drives the simulated eyeball 100 to move about the axial direction of the first rotating assembly 230, a position of the pupil on the simulated eyeball 100 in the vertical direction changes, the angle between the gaze direction and a horizontal plane changes accordingly, and adjustment of the pitch angle is achieved.

It should be understood that, if the line formed by connecting the pupil and the eyeball center is collinear with or parallel to the axial direction of the first rotating assembly 230, when the first rotating assembly 230 drives the simulated eyeball 100 to move about the axial direction of the first rotating assembly 230, the pupil of the simulated eyeball 100 lies in a plane where the rotation axis is located, the position of the pupil in the vertical direction remains unchanged, and the adjustment of the pitch angle cannot be achieved.

In actual implementation, an arrangement angle of the rotation axis of the first rotating assembly 230 may be adjusted based on an angle range of the pitch angle to be adjusted for the simulated eyeball 100. The first rotating assembly 230 may be arranged in a horizontal direction, or may be arranged such that the first rotating assembly 230 is inclined at a certain angle relative to the horizontal direction.

For example, the axial direction of the first rotating assembly 230 is horizontal, and the first angle is formed between the line connecting the pupil and the eyeball center and the axial direction of the first rotating assembly 230. When the first rotating assembly 230 drives the simulated eyeball 100 to rotate, a motion trajectory of the pupil on the simulated eyeball 100 lies in a plane in the vertical direction, to achieve pitch angle adjustment of the gaze direction of the simulated eyeball 100.

For another example, the axial direction of the first rotating assembly 230 is inclined at the certain angle relative to the horizontal direction, and the axial direction of the first rotating assembly 230 is not completely vertical. The first angle is formed between the line connecting the pupil and the eyeball center and the axial direction of the first rotating assembly 230. When the first rotating assembly 230 drives the simulated eyeball 100 to rotate, the motion trajectory of the pupil on the simulated eyeball 100 lies in a non-horizontal plane, and the pitch angle adjustment can also be achieved.

In this embodiment, the pitch angle adjustment of the simulated eyeball 100 may be implemented through a first driving assembly, and horizontal azimuth angle adjustment of the simulated eyeball 100 may be implemented through a second driving assembly.

In actual implementation, the first driving assembly may include a first driving unit and the first rotating assembly 230. The first driving unit is configured to drive the first rotating assembly 230 to rotate the simulated eyeball 100 about the axial direction of the first rotating assembly 230, to adjust the pitch angle of the simulated eyeball 100.

The second driving assembly may include a second driving unit and the second rotating assembly 240. The second driving unit is configured to drive the second rotating assembly 240, such that the simulated eyeball 100 and the first rotating assembly 230 synchronously rotate about the axial direction of the second rotating assembly 240.

In this embodiment, the first driving unit is a power source for driving the first rotating assembly 230 to rotate, and the second driving unit is a power source for driving the second rotating assembly 240 to rotate. The first driving unit and the second driving unit may be stepper motors, direct-current motors, etc.

It should be understood that independent rotation of the second rotating assembly 240 may not affect the pitch angle of the simulated eyeball 100. The first rotating assembly 230 and the second rotating assembly 240 respectively adjust the pitch angle and the horizontal azimuth angle of the simulated eyeball 100, such that the gaze direction of the simulated eyeball 100 may gaze at any to-be-tracked target point.

The rotation axis of the first rotating assembly 230 and the rotation axis of the second rotating assembly 240 are non-parallel and lie in the two non-parallel planes, to ensure that, when the simulated eyeball apparatus tracks the target point, based on the position information of the simulated eyeball 100 and the position information of the target point as well as the first angle, the first rotating assembly 230 drives the simulated eyeball 100 to rotate to adjust the pitch angle of the simulated eyeball 100, and the second rotating assembly 240 drives the simulated eyeball 100 and the first rotating assembly 230 to rotate synchronously to adjust the horizontal azimuth angle of the simulated eyeball 100.

In actual implementation, the axial direction of the first rotating assembly 230 and the axial direction of the second rotating assembly 240 may be perpendicular to each other, which is applicable to gazing at a target located in front of the simulated eyeball 100. The axial direction of the first rotating assembly 230 may be arranged to incline upward or downward relative to the horizontal direction, achieving gazing of the simulated eyeball 100 at a target point with a relatively large pitch angle.

The simulated eyeball apparatus is configured to, based on eyeball coordinate information of the simulated eyeball 100 and position information of a to-be-tracked target point, adjust the pitch angle by causing the first rotating assembly 230 to drive the simulated eyeball 100 to rotate by a first target angle, and adjust the horizontal azimuth angle by causing the second rotating assembly 240 to drive the simulated eyeball 100 to rotate by a second target angle, achieving gazing of the simulated eyeball at the target point.

The first target angle corresponds to an angle to which the first rotating assembly 230 is required to drive the simulated eyeball 100 to rotate, and the second target angle corresponds to an angle to which the second rotating assembly 240 is required to drive the simulated eyeball 100 and the first rotating assembly 230 to rotate simultaneously.

After the first rotating assembly 230 drives the simulated eyeball 100 to rotate by the first target angle, and the second rotating assembly 240 drives the simulated eyeball 100 and the first rotating assembly 230 to rotate by the second target angle, the pupil of the simulated eyeball 100 and the target point can be adjusted to be collinear, that is, the gaze direction is align with the target point.

It should be understood that eyeball coordinate information for two simulated eyeballs 100 differs, and the first target angle and the second target angle for the two simulated eyeballs 100 also differ.

In this embodiment, the first target angle and the second target angle may be calculated by obtaining a difference between current eyeball coordinate information of the simulated eyeball 100 and eyeball coordinate information corresponding to the simulated eyeball 100 when rotated to gaze at the target point.

A control parameter for controlling the first rotating assembly 230 to rotate by the first target angle and the second rotating assembly 240 to rotate by the second target angle is calculated based on the first target angle and the second target angle, and is output as a corresponding target control instruction. The first driving unit controls the first rotating assembly 230 to rotate by the first target angle, and the second driving unit controls the second rotating assembly 240 to rotate by the second target angle, achieving gazing of the simulated eyeball 100 at the target point.

In actual implementation, a rotation direction, a speed, and other parameters of the first driving unit and the second driving unit may be controlled by a motion controller of the simulated eyeball apparatus, to drive the first rotating assembly 230 and the second rotating assembly 240 to rotate. The first driving unit and the second driving unit move simultaneously, to achieve pitch angle rotation and horizontal rotation of the simulated eyeball 100 and simulate the multi-dimensional complex movement of the human eyes.

The pitch angle rotation and the horizontal rotation of the simulated eyeball 100 can be independently controlled.

According to the simulated eyeball apparatus provided in the embodiments of the present disclosure, through arrangement of the first rotating assembly 230 and the second rotating assembly 240, omnidirectional angular adjustment of the simulated eyeball 100 is achieved. By decomposing an action of the simulated eyeball 100 gazing at the target point into rotation of the first rotating assembly 230 and rotation of the second rotating assembly 240, the simulated eyeball 100 gazes at the target point through the pitch angle rotation and the horizontal azimuth rotation. In this way, the multi-dimensional complex movement of the human eyes is accurately simulated, and motion control accuracy of the simulated eyeball is effectively improved.

In some embodiments, the simulated eyeball apparatus further includes an eyeball base 260 at which the simulated eyeball 100 is located.

The first rotating assembly 230 is connected to the simulated eyeball 100 via the eyeball base 260. The second rotating assembly 240 is connected to the first rotating assembly 230 and the simulated eyeball 100 via the eyeball base 260. The second rotating assembly 240 drives the first rotating assembly 230 and the simulated eyeball 100 to rotate synchronously.

A third driving assembly is correspondingly connected to two eyeball bases 260 and drives the two eyeball bases 260 to move towards or away from each other, to adjust a pupil distance between the two simulated eyeballs 100.

In this embodiment, the two eyeball bases 260 may be arranged side by side in a first direction, and each eyeball base 260 is provided with one simulated eyeball 100.

It should be understood that an orientation relationship indicated by the first direction is merely for the convenience of describing arrangement of the two eyeball bases 260, and does not indicate or imply that the referenced eyeball base 260 or simulated eyeball 100 must have a specific orientation relationship.

For example, the first direction may be a horizontal left-right direction, a horizontal front-rear direction, or any other directions.

The eyeball base 260 is a base for placing the simulated eyeball 100. Mechanisms such as a first support 210, the first rotating assembly 230, and the second rotating assembly 240 may also be disposed on the eyeball base 260.

In actual implementation, the simulated eyeball 100, the first support 210, and the first rotating assembly 230 may be disposed at an upper cover of the eyeball base 260. The second rotating assembly 240 may be disposed in a receiving cavity of the eyeball base 260. A portion extending from the upper cover is connected to the first support 210, and drives the simulated eyeball 100, the first support 210, and the first rotating assembly 230 to rotate together in the horizontal direction.

In this embodiment, the second driving unit may also be disposed in the receiving cavity of the eyeball base 260. The second rotating assembly 240 has an end connected to an output end of the second driving unit, and the other end connected to the first support 210.

In some embodiments, when the two simulated eyeballs 100 are at an initial position, a second angle is formed between axial directions of the two first rotating assemblies 230.

It should be noted that the simulated eyeball 100, the first support 210 of the simulated eyeball 100, and the first rotating assembly 230, belong to relatively protruding structures in the simulated eyeball apparatus. (The second rotating assembly 240 is arranged vertically and may be disposed inside the eyeball base 260 of the simulated eyeball 100, and is relatively non-protruding.) If the two first rotating assemblies 230 are placed facing a same direction, the rotation of the second rotating assembly 240 may cause mechanical interference among structures such as the simulated eyeball 100, the first support 210, and the first rotating assembly 230. Also, the protruding simulated eyeball 100 may also cause mechanical interference with a device under test, such as an eye tracker, affecting test results of the device.

As illustrated in FIG. 2, when the two simulated eyeballs 100 are at the initial position, the second angle is formed between the axial directions of the two first rotating assemblies 230, that is, the relatively protruding simulated eyeballs 100 are placed in a deflected manner, to reserve an interference-free rotation space for the structures such as the simulated eyeball 100, the first support 210, and the first rotating assembly 230. When the second rotating assembly 240 rotates, the mechanical interference among the simulated eyeball 100, the first support 210, the first rotating assembly 230 and other structures can be avoided. The rotation of the two first rotating assemblies 230 do not interfere with each other, ensuring normal rotation operation of the simulated eyeball 100 in two directions.

In this embodiment, the second angle is formed between the axial directions of the two first rotating assemblies 230, and the simulated eyeballs 100 are placed in a deflected manner, in such a manner that mechanical interference of the simulated eyeball apparatus can be effectively prevented.

In some embodiments, the simulated eyeball apparatus may further include a third driving assembly for adjusting the pupil distance between the two simulated eyeballs 100.

In this embodiment, the third driving assembly is connected to the two eyeball bases 260. The third driving assembly is configured to drive the two eyeball bases 260 to move towards or away from each other in the first direction, to adjust the pupil distance between the two simulated eyeballs 100.

It should be understood that the simulated eyeball 100 is disposed on the eyeball base 260. When the third driving assembly drives the two eyeball bases 260 to move towards or away from each other, a distance between the two eyeball bases 260 changes, and the pupil distance between the two simulated eyeballs 100 changes accordingly. The motion controller may control the third driving assembly to adjust the pupil distance between the two simulated eyeballs 100, to simulate human eye conditions with different pupil distances.

In some embodiments, the third driving assembly includes a third driving unit and a linear sliding table 270 connected to the third driving unit. The two eyeball bases 260 are disposed at the linear sliding table 270.

In this embodiment, the motion controller outputs a control instruction to the third driving unit. Driven by the third driving unit, the linear sliding table 270 may drive the two eyeball bases 260 to perform linear movement, adjusting the pupil distance between the two simulated eyeballs 100.

It should be understood that the third driving unit is a power source for driving the linear sliding table 270. The third driving unit may be a stepper motor, a direct-current motor, or the like.

In actual implementation, the simulated eyeball apparatus may include a device base. A receiving space is defined in the device base for receiving the third driving unit. The linear sliding table 270 is mounted on the device base, and the two eyeball bases 260 are disposed at the linear sliding table 270. Driven by the third driving unit, adjustment of the pupil distance between the two simulated eyeballs 100 is achieved.

In some embodiments, a maximum rotation angle of the second rotating assembly 240 is determined based on the pupil distance between the two simulated eyeballs 100.

It should be understood that by analyzing gazing directions of the two simulated eyeballs 100 based on the pupil distance between the two simulated eyeballs 100, a rotation angle range that may cause mechanical interference between the two simulated eyeballs 100 can be determined, and further a maximum rotation angle for the second rotating assembly 240 to drive the simulated eyeball 100 to rotate in the horizontal direction can be determined.

In some embodiments, a maximum rotation angle of the first rotating assembly 230 is 360°, and the maximum rotation angle of the second rotating assembly 240 is less than 360°.

In this embodiment, the first rotating assembly 230 may drive the simulated eyeball 100 to perform omnidirectional angular rotation by 360° to adjust the pitch angle of the simulated eyeball 100. The maximum rotation angle by which the second rotating assembly 240 drives the simulated eyeball 100 is less than 360°, which can avoid the mechanical interference among the structures such as the simulated eyeball 100, the first support 210, and the first rotating assembly 230. A rotation angle of less than 360° also better conforms to the rotation law of real human eyes.

In some embodiments, the simulated eyeball apparatus further includes the first support 210.

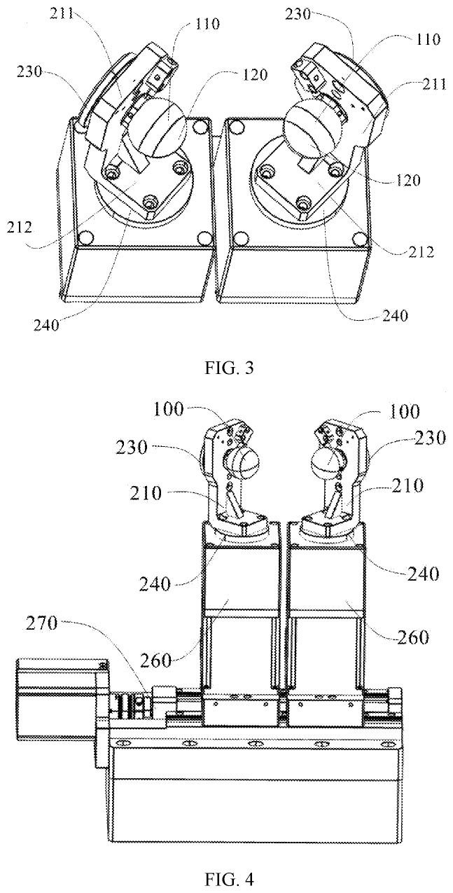

As illustrated in FIG. 3, the first support 210 includes a first fixing plate 211 and a second fixing plate 212 perpendicular to the first fixing plate 211. The other end of the first rotating assembly 230 passes through a mounting hole of the first fixing plate 211 and is connected to the simulated eyeball 100. The other end of the second rotating assembly 240 is connected to the second fixing plate 212.

The first support 210 is a frame for supporting and mounting the simulated eyeball 100. Each simulated eyeball 100 corresponds to one first support 210.

In this embodiment, the simulated eyeball 100 is mounted on the first support 210. The first rotating assembly 230 is mounted at the first fixing plate 211. The second rotating assembly 240 is mounted at the second fixing plate 212. The first rotating assembly 230 drives the simulated eyeball 100 to rotate. The second rotating assembly 240 drives the first support 210, the simulated eyeball 100, and the first rotating assembly 230 to rotate together.

It should be noted that, when the two simulated eyeballs 100 are at the initial position, an angle is formed between the axial directions of the two first rotating assemblies 230. As a relatively protruding structure in the simulated eyeball apparatus, the first support 210 allows the simulated eyeball 100 to be placed in a deflected manner, which can avoid mechanical interference between the first support 210 and the first rotating assembly 230 on the first support 210.

In actual implementation, the first driving unit may also be disposed at the first fixing plate 211. The first driving unit is mounted at one face of the first fixing plate 211. The first rotating assembly 230 has an end connected to an output end of the first driving unit, and the other end passing through a mounting hole of the first fixing plate 211. The other end of the first rotating assembly 230 is connected to the simulated eyeball 100 at the other face of the first fixing plate 211.

In some embodiments, the simulated eyeball 100 may include a spherical structure 110 and an artificial iris decal 120. A sphere of the spherical structure 110 has a cut surface, the artificial iris decal 120 covers the cut surface, and a radius of the artificial iris decal 120 is smaller than a radius the spherical structure 110.

The spherical structure 110 is a spherical structure simulating a human eye. The spherical structure 110 has the cut surface, and the cut surface is covered with the artificial iris decal 120 simulating an iris of the human eye. The iris has a dimension smaller than a dimension of an entire eyeball. The radius of the artificial iris decal 120 can be set based on iris radii of different human eyes.

In this embodiment, by designing the spherical structure 110 and the artificial iris decal 120, different dimensions, curvatures and radian profiles of the human eyes can be simulated, such that the simulated eyeball 100 is closer to a real human eye.

In actual implementation, the spherical structure 110 may be manufactured by a 3D printing technology or a numerical control machine tool technology. When the simulated eyeball apparatus is used for testing, the spherical structure 110 and the artificial iris decal 120 can be identified by a camera image recognition technology to track an eye movement trajectory.

In some embodiments, the cut surface of the spherical structure 110 is perpendicular to the axial direction of the first rotating assembly 230.

As illustrated in FIG. 4, the cut surface of the spherical structure 110 is perpendicular to the axial direction of the first rotating assembly 230. A center of the artificial iris decal 120 covering the cut surface is positioned at the pupil. When the first rotating assembly 230 drives the simulated eyeball 100 to rotate, a movement trajectory of the pupil of the artificial iris decal 120 is not a maximum circular cut surface formed by movement of the spherical structure 110, and there is a certain angle difference between a pupil trajectory and a vertical plane in front of the simulated eyeball apparatus.

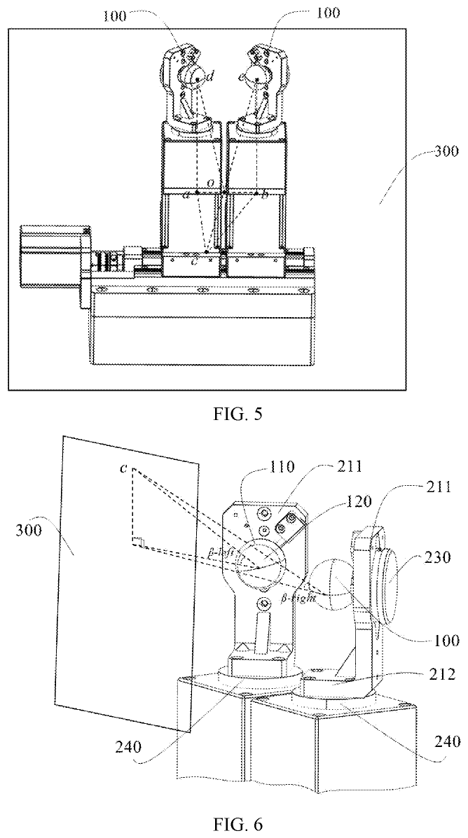

For example, as illustrated in FIG. 5, when the first rotating assembly 230 of the simulated eyeball 100 corresponding to a left eye rotates clockwise, the pupil initially facing a display screen 300 gradually moves away from the display screen 300, and a certain angle is formed between a motion trajectory of the pupil projected on the horizontal plane and the display screen 300.

In this embodiment, the rotation of the first rotating assembly 230 of the simulated eyeball 100 adjusts the pitch angle of the simulated eyeball 100 and causes a certain position deviation of the pupil. The second rotating assembly 240 of the simulated eyeball 100 is controlled to rotate to perform angle compensation.

For example, when the pupil of the simulated eyeball 100 corresponding to the left eye moves away from the display screen 300, the angle compensation is performed by controlling the second rotating assembly 240 of the simulated eyeball 100 to rotate clockwise, to reduce a distance between the pupil and the display screen 300.

In some embodiments, the simulated eyeball apparatus may further include a fourth driving assembly connected to the eyeball base 260.

Each fourth driving assembly is connected to one eyeball base 260. The fourth driving assembly is configured to drive the eyeball base 260 to move in the axial direction of the second rotating assembly 240, to adjust a height of the simulated eyeball 100.

In this embodiment, the eyeball base 260 is a liftable base. The motion controller outputs a control instruction to the fourth driving assembly. Driven by the fourth driving assembly, the eyeball base moves in the axial direction of the second rotating assembly 240 to adjust the height of the simulated eyeball 100.

The simulated eyeball apparatus in the above embodiments of the present disclosure can achieve pitch angle rotation, horizontal rotation, pupil distance adjustment, and height adjustment, and can accurately simulate the multi-dimensional complex movement of the different human eyes.

The embodiments of the present disclosure further provide an eye movement tracking control method. By keeping the pupil distance, the action of the simulated eyeball 100 gazing at the target point is decomposed into the rotation of the first rotating assembly 230 and the rotation of the second rotating assembly 240. Complex eyeball movement is accurately simulated through the pitch angle rotation and the horizontal rotation.

The eye movement tracking control method in the embodiments of the present disclosure method is applied in the two simulated eyeballs 100. Each of the two simulated eyeballs 100 has the first rotating assembly 230 and the second rotating assembly 240 for tracking the target point. The rotation axis of the first rotating assembly 230 and the rotation axis of the second rotating assembly 240 are non-parallel and lie in the two non-parallel planes. The first angle is formed between the line connecting the pupil and the eyeball center of the simulated eyeball 100 and the axial direction of the first rotating assembly 230.

The eye movement tracking control method in the embodiments of the present disclosure can be used to control the movement of the simulated eyeball 100 of the above simulated eyeball apparatus, to accurately simulate complex continuous eyeball movement.

An executor of the eye movement tracking control method provided in the embodiments of the present disclosure may be an electronic device, or a function module or a function entity capable of implementing the eye movement tracking control method in the electronic device. The eye movement tracking control method provided in the embodiments of the present disclosure is described below by taking the electronic device as the executor.

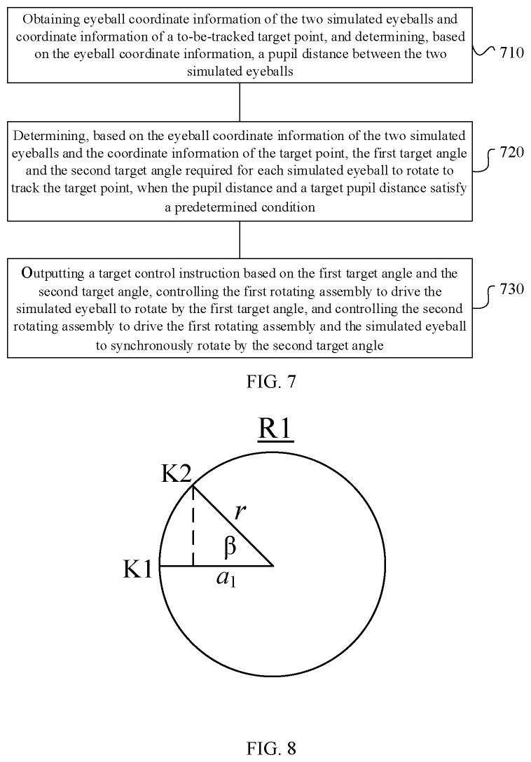

As illustrated in FIG. 7, the eye movement tracking control method includes block 710 to block 730.

At block 710, eyeball coordinate information of the two simulated eyeballs 100 and coordinate information of the to-be-tracked target point are obtained, and the pupil distance between the two simulated eyeballs 100 is determined based on the eyeball coordinate information.

In this operation, a spatial rectangular coordinate system may be established, and the coordinate information of the target point and the eyeball coordinate information of the two simulated eyeballs 100 are obtained based on a relative position relationship between the simulated eyeball 100 and the target point.

For example, as illustrated in FIG. 5, the simulated eyeball 100 gazes at a target point of the display screen 300. When the simulated eyeball apparatus is at the initial position, eyeball centers of the two simulated eyeballs 100 are respectively d and e, and vertical mapping points of d and e on the display screen 300 are respectively a and b. ad=be=h, where h represents a visual depth, that is, a distance between the eyeball center of the simulated eyeball 100 and the display screen 300. de=IPD, where IPD represents the pupil distance.

A midpoint of a line connecting the point a and the point b is a screen center point O of the display screen 300, and a point c is a target point on the display screen 300.

A spatial rectangular coordinate system may be established by taking a midpoint of a line connecting the two simulated eyeballs 100 (the midpoint of the line connecting the point d and the point e) as the coordinate origin, the line connecting the two simulated eyeballs 100 as the X-axis, a line extending from the midpoint of the line connecting the two simulated eyeballs 100 to the screen center point of the display screen 300 as the y-axis, and the vertical direction as the z-axis.

Coordinate information (x₀, h, z₀) of the point c is obtained based on a relative position relationship between the point c and the screen center point O. The eyeball coordinate information of the two simulated eyeballs 100 are (1/2IPD, 0, 0) and (−1/2IPD, 0, 0) respectively.

In this embodiment, a spatial rectangular coordinate system may be established at a certain position of the simulated eyeball apparatus, or at a certain position of the display screen 300, to obtain the coordinate information of the target point and the eyeball coordinate information of the two simulated eyeballs 100.

It should be noted that the eyeball coordinate information of the simulated eyeball 100 includes coordinate information of the simulated eyeball 100 at each position, for example, coordinate information of structural positions such as the spherical structure 110, the artificial iris decal 120, and the pupil.

In this operation, the pupil distance is calculated based on the eyeball coordinate information of the two simulated eyeballs 100, that is, a distance of a line connecting eyeball centers of the two simulated eyeballs 100.

For example, the eyeball coordinate information of the two simulated eyeballs 100 are (1/2IPD, 0, 0) and (−1/2IPD, 0, 0) respectively, and the pupil distance between the two simulated eyeballs 100 is IPD.

At block 720, when the pupil distance and a target pupil distance satisfy a predetermined condition, based on the eyeball coordinate information of the two simulated eyeballs 100 and the coordinate information of the target point, the first target angle and the second target angle required for each simulated eyeball 100 to rotate to track the target point are determined.

The target pupil distance is a predetermined pupil distance value.

It should be noted that, when the pupil distance and the target pupil distance satisfy the predetermined condition, the pupil distance may be equal to the target pupil distance, or the pupil distance is in a multiple relationship with the target pupil distance.

For example, when the pupil distance between the two simulated eyeballs 100 is equal to a predetermined target pupil distance, a position deviation between a line-of-sight direction of the simulated eyeball 100 and the target point is determined based on the eyeball coordinate information and the coordinate information of the two simulated eyeballs 100. Such a position deviation is adjusted through the rotation of the first rotating assembly 230 and the rotation of the second rotating assembly 240, such that the line-of-sight direction of the simulated eyeball 100 faces directly towards the target point, that is, the simulated eyeball 100 gazes at the target point.

The first target angle corresponds to an angle to which the first rotating assembly 230 shall drive the simulated eyeball 100 to rotate when the simulated eyeball 100 tracks the target point. The second target angle corresponds to an angle to which the second rotating assembly 240 shall drive the first rotating assembly 230 and the simulated eyeball 100 to rotate synchronously when the simulated eyeball 100 tracks the target point.

In this operation, based on the coordinate information of the target point and the eyeball coordinate information of the simulated eyeball 100, a position deviation between the gaze direction of the simulated eyeball 100 and the target point is determined, and through the rotation of the first rotating assembly 230 and the rotation of the second rotating assembly 240, the gaze direction of the simulated eyeball 100 is adjusted to directly face the target point.

In actual implementation, the first target angle and the second target angle may be calculated based on a difference between current coordinate information of the simulated eyeball 100 and eyeball coordinate information corresponding to the simulated eyeball 100 being rotated to gaze at the target point.

After the first rotating assembly 230 drives the simulated eyeball 100 to rotate by the first target angle, and the second rotating assembly 240 drives the simulated eyeball 100 and the first rotating assembly 230 to synchronously rotate by the second target angle, the eyeball center and the pupil of the simulated eyeball 100 can be adjusted to be collinear with the target point, that is, the gaze direction of the simulated eyeball 100 directly faces the target point.

It should be understood that the eyeball coordinate information for the two simulated eyeballs 100 differs, and the first target angle and the second target angle for the two simulated eyeballs 100 also differ.

At block 730, a target control instruction is output based on the first target angle and the second target angle, the first rotating assembly 230 is controlled to drive the simulated eyeball to rotate by the first target angle, and the second rotating assembly 240 is controlled to drive the first rotating assembly 230 and the simulated eyeball 100 to synchronously rotate by the second target angle.

In this embodiment, a control parameter for controlling the first rotating assembly 230 to rotate by the first target angle and the second rotating assembly 240 to rotate by the second target angle is calculated to obtain a corresponding target control instruction. The first rotating assembly 230 is controlled to rotate by the first target angle, and the second rotating assembly 240 is controlled to rotate by the second target angle, achieving gazing of the simulated eyeball 100 at the target point.

By way of example, the first rotating assembly 230 drives the simulated eyeball 100 to rotate in the vertical direction, to adjust the pitch angle; and the second rotating assembly 240 drives the simulated eyeball 100 to rotate in the horizontal direction.

In this embodiment, the first target angle P_{c} and the second target angle Q_{c} are calculated based on the coordinate information and the eyeball coordinate information, and the corresponding target control instruction is output. After the first rotating assembly 230 rotates by P_{c} and the second rotating assembly 240 rotates by Q_{c}, the gaze direction of the simulated eyeball 100 can be adjusted to directly face the target point.

According to the eye movement tracking control method provided in the embodiments of the present disclosure, the pupil distance between the two simulated eyeballs 100 is kept. By obtaining the coordinate information of the target point and the eyeball coordinate information, the action of the simulated eyeball 100 gazing at the target point is decomposed into the rotation of the first rotating assembly 230 and the rotation of the second rotating assembly 240 for motion control, achieving gazing of the simulated eyeball 100 at the target point. In this way, the motion control accuracy of the simulated eyeball apparatus is improved, and the complex eyeball movement is accurately simulated through the pitch angle rotation and the horizontal rotation.

In some embodiments, the eye movement tracking control method may further include: adjusting the pupil distance between the two simulated eyeballs 100, when the pupil distance between the two simulated eyeballs 100 and the target pupil distance do not satisfy the predetermined condition, until the pupil distance between the two simulated eyeballs 100 and the target pupil distance satisfy the predetermined condition.

For example, the third driving assembly of the simulated eyeball apparatus may drive the two eyeball bases 260 to move towards or away from each other, to change the pupil distance between the two simulated eyeballs 100 until the pupil distance between the two simulated eyeballs 100 is adjusted to the target pupil distance. In this way, angle decomposition for subsequent rotation of the first rotating assembly 230 and subsequent rotation of the second rotating assembly 240 is facilitated, and the motion control accuracy of the simulated eyeball 100 is improved.

In some embodiments, block 730 of determining, based on the eyeball coordinate information of the two simulated eyeballs 100 and the coordinate information of the target point, the first target angle and the second target angle required for each of the simulated eyeballs 100 to rotate to track the target point includes: determining, based on the eyeball coordinate information and the coordinate information of the target point, a target pitch angle at which the simulated eyeball 100 gazes at the target point; determining a first target angle of the simulated eyeball 100 based on the target pitch angle and the first angle; and determining the second target angle based on the eyeball coordinate information, the coordinate information of the target point, and the first target angle.

In this embodiment, based on the eyeball coordinate information, the target pitch angle required for each simulated eyeball 100 to gaze at the target point may be calculated by using a right triangle algorithm for the pitch angle. The target pitch angle is used to characterize the angle between the gaze direction of the pupil and the horizontal plane when the simulated eyeball 100 gazes at the target point.

As illustrated in FIG. 6, a triangle may be formed by connecting three points: the target point on the display screen 300, and the two simulated eyeballs 100. The target pitch angle of each simulated eyeball 100 gazing at the target point can be calculated by using the right triangle algorithm for the pitch angle.

With the angle between the gaze direction of the pupil and the horizontal plane being equal to the target pitch angle as a basis, trigonometric function operation is performed to obtain coordinate information in a vertical direction of a target position of the pupil when the simulated eyeball 100 rotates to gaze at the target point.

It should be noted that the first angle is formed between the axial direction of the first rotating assembly 230 and the gaze direction of the simulated eyeball 100. Movement of a pupil position driven by the rotation of the first rotating assembly 230 is related to the first angle, that is, the first angle needs to be combined for calculation when the first target angle is calculated.

For example, the first angle of 45° is formed between the first rotating assembly 230 and the gaze direction of the simulated eyeball 100. When the target pitch angle for rotation of the simulated eyeball 100 is within an angle range of −45°≤6≤45°, the first target angle within a range of −45°≤6≤45° can be obtained through rectangular coordinate system transformation and trigonometric function conversion. That is, when the first rotating assembly 230 rotates by 360°, the first rotating assembly 230 can drive the simulated eyeball 100 to adjust the pitch angle within an angle range of −45°≤6≤45°

In actual implementation, the first rotating assembly 230 drives the simulated eyeball 100 to move about the axial direction of the first rotating assembly 230, and drives the pupil to move from a current position to a target position for gazing at the target point. The first target angle is calculated based on the current position and the target position in combination with the first angle.

It should be noted that specific calculation and derivation of the target pitch angle based on the eyeball coordinate information and the coordinate information of the target point is derived by those skilled in the art based on the calculation principle of the angle between the gaze direction and the horizontal plane, which will not be elaborated herein. It should be understood that when the two simulated eyeballs 100 are arranged side by side, the two simulated eyeballs 100 correspond to the left eye and the right eye of the human eyes respectively. The eyeball coordinate information of the two simulated eyeballs 100 is different, so their corresponding target pitch angles are also different, denoted as β-left and β-right respectively, and the first target angle calculated in combination with the first angle is also different.

For example, as illustrated in FIG. 6, the two simulated eyeballs 100 are arranged side by side and correspond to the left eye and the right eye respectively. Driven by the first rotating assembly 230, the two simulated eyeballs 100 gaze at the target point c on the display screen 300. The two simulated eyeballs 100 correspond to pitch angles β-left and β-right respectively.

It should be understood that, after a rotation angle of the first rotating assembly 230 is fixed, the rotation of the second rotating assembly 240 may not change the pitch angle of the simulated eyeball 100. After the first target angle is calculated, the second target angle is further calculated in combination with the coordinate information of the target point and the eyeball coordinate information of the simulated eyeball 100.

In some embodiments, determining the second target angle based on the eyeball coordinate information, the coordinate information of the target point, and the first target angle may include: determining, based on the first target angle and the motion trajectory of the pupil, a projection displacement deviation of the pupil on the horizontal plane prior to and subsequent to the rotation of the first rotating assembly 230; determining a second compensation angle based on the projection displacement deviation and a distance between the projection and the eyeball center, where the second compensation angle compensates for an angular deflection of the pupil on the horizontal plane; determining a target azimuth angle of the simulated eyeball 100 on the horizontal plane based on the coordinate information of the target point and the eyeball coordinate information; and determining the second target angle based on the second compensation angle and the target azimuth angle.

It should be noted that when the first rotating assembly 230 rotates by the first target angle, vertical projection of the motion trajectory of the pupil of the simulated eyeball 100 onto the horizontal plane may cause a certain displacement (i.e., projection displacement deviation), which causes an angular deflection of the pupil in the horizontal azimuth direction. The second compensation angle is calculated to compensate for the angular deflection of the pupil in the horizontal plane when the first rotating assembly 230 rotates by the first target angle.

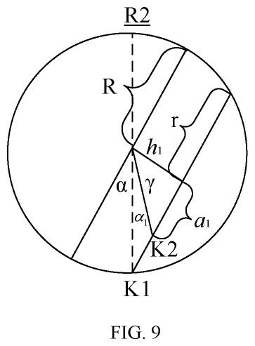

For example, as illustrated in FIG. 8, a circle R1 is the motion trajectory of the pupil of the simulated eyeball 100 rotating for one cycle, and r denotes a radius of a plane where the pupil motion trajectory is located.

In this embodiment, the first rotating assembly 230 rotates by the first target angle β, and the pupil moves from a position K1 to a position K2. Based on a trigonometric relationship in the circle, a projection displacement deviation α₁=r×cos β in the horizontal plane by the rotation of the first rotating assembly 230 at the first target angle can be calculated.

As illustrated in FIG. 9, a circle R2 is a vertical projection of the simulated eyeball 100, which can be regarded as a projection of a cross section of the second rotating assembly 240. When the pupil moves from the position K1 to the position K2, a resulting angular deflection is α, that is, the second compensation angle is α₁. The distance between the projection and the eyeball center may be a distance from a plane of an actual motion trajectory of the pupil to the eyeball center.

In this embodiment, based on the projection displacement deviation a₁ and the distance h₁ between the projection and the eyeball center, an angle

$$γ = arctan \frac{{a}_{1}}{{h}_{1}}$$

can be calculated by means of a trigonometric relationship of the vertical projection, and the second compensation angle α₁ can be calculated by drawing auxiliary dashed lines.

A specific embodiment for calculating the second compensation angle α₁ is introduced below.

As illustrated in FIG. 6, the second angle of 90° is formed between the axial directions of the first rotating assemblies 230 of the two simulated eyeballs 100. An angle α′ between a plane perpendicular to the axial direction of the first rotating assembly 230 and the display screen 300 directly in front of the simulated eyeball 100 is 45°.

The simulated eyeball 100 is arranged in a deflected manner. An angle formed between a maximum cross section of the sphere of the simulated eyeball 100 and the display screen 300 directly in front of the simulated eyeball 100 can be calculated based on the second angle. Based on this angle, an angle α between the auxiliary dashed line shown in FIG. 6 and the maximum cross section of the sphere can be calculated.

A sum of the angle α, the second compensation angle α₁, and an angle γ is 90°. The second compensation angle satisfies α₁=90°−α−γ.

When the second angle of 90° is formed between the axial directions of the first rotating assemblies 230 of the two simulated eyeballs 100, the angle α between the plane perpendicular to the axial direction of the first rotating assembly 230 and the display screen 300 in front of the simulated eyeball 100 is 45°.

In this embodiment, after the first rotating assembly 230 rotates by the first target angle P_{c}, the second compensation angle to be compensated by the second rotating assembly 240 in the horizontal direction satisfies α₁=45°−arctan (cos p_{c})

It should be understood that the deflected arrangement of the two simulated eyeballs 100 may reserve an interference-free rotation space for structures such as the simulated eyeball 100 and the first rotating assembly 230. When the second rotating assembly 240 rotates, mechanical interference among the simulated eyeball 100, the first rotating assembly 230 and other structures can be avoided, and the rotation of the two first rotating assemblies 230 will not affect each other.

It should be noted that after the first rotating assembly 230 rotates by the first target angle, the angle between the gaze direction of the simulated eyeball 100 and the horizontal plane reaches the target pitch angle. After the second rotating assembly 240 rotates by the second compensation angle for compensation, the pupil returns to the initial position in the horizontal direction. That is, a vertical coordinate of the pupil changes (to form the target pitch angle with the horizontal plane), while the horizontal coordinate remains unchanged. Based on coordinate information of this initial position and coordinate information of the target point, the target azimuth angle can be calculated to complete full adjustment of the horizontal azimuth angle of the simulated eyeball 100.

It should be understood that the target azimuth angle is calculated based on the coordinate information of the pupil at its initial position and at the target position for gazing at the target point. Calculation of the target azimuth angle is independent of the second compensation angle. Alternatively, the second compensation angle may be calculated first, and a calculation sequence is not limited.

In this embodiment, when the simulated eyeball 100 gazes at the target point, the eyeball center, the pupil, and the target point are collinear (in the gaze direction). The target azimuth angle α₂ can be determined based on the coordinate information of the target point and original eyeball coordinate information.

In this embodiment, the second target angle rotated by the second rotating assembly 240 is equal to a sum of the second compensation angle and the target azimuth angle, that is, the second target angle satisfies Q_{c}=α₁+α₂. When the first rotating assembly 230 rotates by the first target angle and the second rotating assembly 240 rotates by the second target angle, the gaze direction of the pupil directly faces the target point, that is, the simulated eyeball 100 gazes at the target point.

A specific embodiment is introduced below.

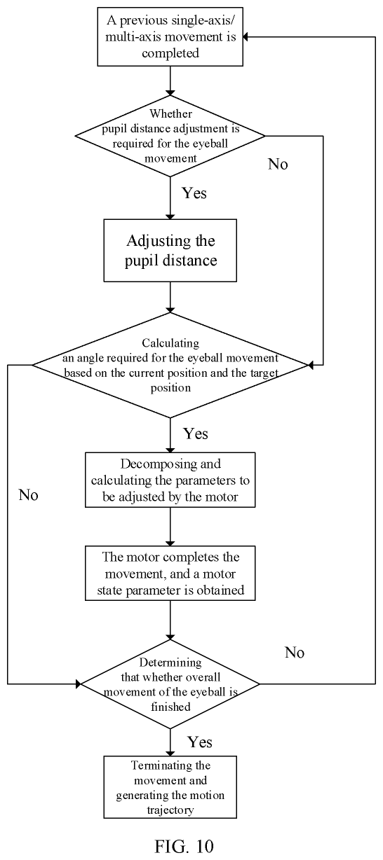

As illustrated in FIG. 10, when a previous single-axis/multi-axis movement of the simulated eyeball apparatus is completed, it is determined that whether pupil distance adjustment is required for the eyeball movement, i.e., whether the pupil distance between the two simulated eyeballs 100 is equal to 64 mm.

When the pupil distance between the two simulated eyeballs 100 is not equal to 64 mm, the pupil distance between the two simulated eyeballs 100 is adjusted to 64 mm by the third driving assembly.

An angle required for the eyeball movement is calculated based on the current position and the target position, where the target position refers to a position of the simulated eyeball 100 when gazing at the target point on the display screen 300.

Based on the eyeball coordinate information and the coordinate information of the target point, a horizontal rotation angle and a pitch rotation angle required for the left eye and the right eye are calculated, which are designated as the first target angle and the second target angle. The first target angle of the first rotating assembly 230 of the left eye is 11.26°, the first target angle of the first rotating assembly 230 of the right eye is 10.19°, and the second target angle of each of the two second rotating assemblies 240 is 15.02°.

Parameters to be adjusted for driving motors of the two rotation axes are calculated and decomposed, the motors are controlled to complete the movement, a motor state parameter is obtained, and it is determined that whether overall movement of the eyeball is finished.

In this embodiment, the pupil distance between the two simulated eyeballs 100 is first adjusted, such that the pupil distance between the two simulated eyeballs 100 and the target pupil distance satisfy the predetermined condition. The action of the simulated eyeball 100 gazing at the target point is then decomposed into the rotation of the first rotating assembly 230 and the rotation of the second rotating assembly 240. The first rotating assembly 230 and the second rotating assembly 240 are controlled to rotate respectively to realize the pitch angle rotation and the horizontal direction rotation, in such a manner that the simulated eyeball 100 gazes at the target point on the display screen 300, and the movement of the simulated eyeball 100 is accurately simulated with high eyeball motion control accuracy.

In some embodiments, the first rotating assembly 230 is driven by the first driving unit. The second rotating assembly 240 is driven by the second driving unit. A plurality of target points are provided. The eye movement tracking control method may further include:

determining a target motion type and a corresponding motion control parameter, subsequent to obtaining coordinate information of the plurality of target points; and controlling, based on the target motion type, the first driving unit and the second driving unit to correspondingly drive the first rotating assembly 230 and the second rotating assembly 240 respectively in accordance with the motion control parameter.

In this embodiment, by obtaining multiple coordinate information of the target point, a motion trajectory of the target point is analyzed, and the target motion type of the target point is identified

For example, the target point may be a point of a scanning motion type. The target point moves line by line on the display screen 300.

For another example, the target point may be a point of a fixation motion type. The target point remains stationary on the display screen 300.

For yet another example, the target point may be a point of a saccade motion type, and the target point jumps randomly on the display screen 300.

Subsequent to determining the target motion type of the target point, the corresponding motion control parameter can be matched based on the target motion type of the target point. The motion control parameter may include a rotation amplitude, a speed, and an acceleration.

When the first rotating assembly 230 and the second rotating assembly 240 are controlled to rotate, motion control is performed based on the calculated first target angle and the calculated second target angle in accordance with a predetermined motion control parameter, to simulate complex and continuous eyeball movement conforming to a motion rule of the target motion type.

In this embodiment, based on a series of coordinate information of the target points, the motion type is automatically determined based on a distance between the target points and an angle difference between the target points, and the corresponding motion parameter is matched. The angle is automatically calculated in accordance with the predetermined motion control logic to control the simulated eyeball 100 to perform the corresponding movement. A specific embodiment is described below.

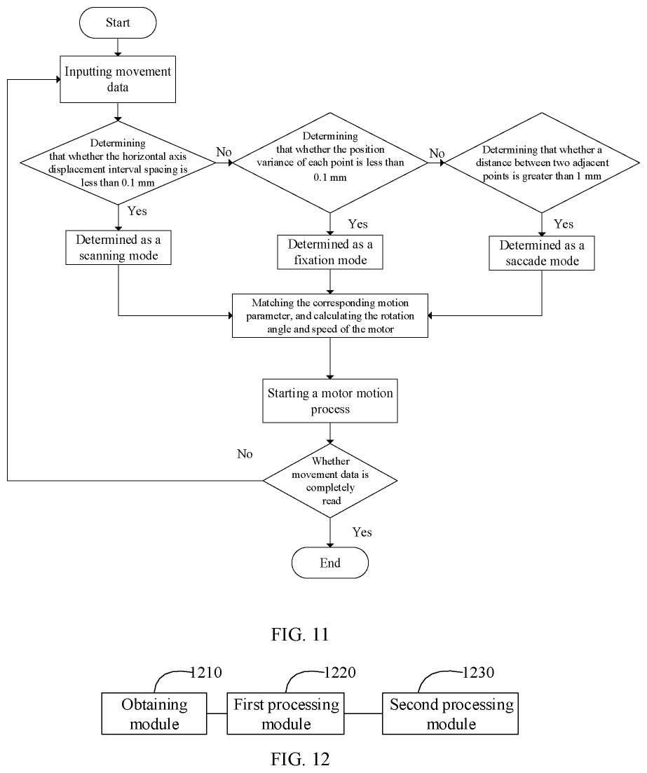

As illustrated in FIG. 11, movement data of the target point is output based on the coordinate information of the plurality of target points.

Horizontal axis displacement interval spacing is calculated based on the movement data. When the horizontal axis displacement interval spacing is less than 0.1 mm, the motion type of the target point is determined to be a scanning mode.

When the horizontal axis displacement interval spacing is greater than or equal to 0.1 mm, a position variance of each point is calculated. When the position variance of each point is less than 0.1 mm, the motion type of the target point is determined to be a fixation mode.

When the position variance of each point is greater than or equal to 0.1 mm, it is determined that whether a distance between two adjacent points is greater than 1 mm. When the distance between the two adjacent points is greater than 1 mm, the motion type of the target point is determined to be a saccade mode.

Subsequent to determining the motion type of the target point, the corresponding motion control parameter is matched based on the motion type, a rotation angle and a speed of the motors for the two rotation axes are calculated, and a motor motion process is started to simulate the movement of the simulated eyeball 100 until all movement data is completely read.

In this embodiment, through motion type determination and motion parameter matching, conjugate movement and vergence eye movement of the human eyes are accurately simulated. Not only are eye movement modes including saccade, smooth tracking, gazing, and vestibulo-ocular reflex simulated, but convergence eye movement and divergence eye movement are also simulated, achieving accurate simulation of the complex and continuous eyeball movement.

In some embodiments, the target motion type is input by a user.

In this embodiment, the target motion type of the target point is input by the user. Based on the coordinate information of the plurality of target points, the simulated eyeball apparatus calculates the target angles of the two rotating axes for the motion control in accordance with the motion control parameter corresponding to the target motion type.

In actual implementation, user input corresponding to the target motion type may be a touch operation, which includes but is not limited to a clicking operation, a sliding operation, and a pressing operation on the simulated eyeball apparatus or other terminal devices connected thereto. Physical key input or voice input may also be acceptable.

Of course, in other embodiments, the user input corresponding to the target motion type may also take other forms, including but not limited to character input. A specific form may be determined based on actual requirements, which is not limited in the embodiments of the present disclosure.

In some embodiments, the target motion type is determined based on the coordinate information of the plurality of target points.

In this embodiment, based on the coordinate information of the plurality of target points, the simulated eyeball apparatus automatically identifies the target motion type of the target point, searches for the motion control parameter corresponding to the target motion type, and calculates the target angles of the two rotating axes for the motion control in accordance with the motion control parameter corresponding to the target motion type.

In some embodiments, the coordinate information of the target point may be obtained through the following operation: obtaining the coordinate information of the target point input by the user.

In this embodiment, the coordinate information of one or more target points is input by a user.

In actual implementation, the user input corresponding to the coordinate information of the target point may be a touch operation, which includes but is not limited to a clicking operation, a sliding operation, and a pressing operation on the simulated eyeball apparatus or other terminal devices connected thereto. Physical key input or voice input may also be acceptable.

Of course, in other embodiments, the user input corresponding to the coordinate information of the target point may also take other forms, which includes but is not limited to character input. A specific form may be determined based on actual requirements, which is not limited in the embodiments of the present disclosure.

In some embodiments, the coordinate information of the target point may be obtained through the following operations: obtaining image information of the target point; and determining the coordinate information of the target point based on the image information of the target point.

In this embodiment, the simulated eyeball apparatus may autonomously identify and obtain the coordinate information of the target point based on the image information of the target point.

In actual implementation, the simulated eyeball apparatus may autonomously identify and obtain the coordinate information of the target point based on an image sequence of the target point, and may also identify the target motion type of the target point based on the coordinate information of the plurality of target points.

In the eye movement tracking control method provided in the embodiments of the present disclosure, the executor may be the eye movement tracking control apparatus. In the embodiments of the present disclosure, the eye movement tracking control apparatus executing the eye movement tracking control method is taken as an example to illustrate the eye movement tracking control apparatus provided in the embodiments of the present disclosure.

The embodiments of the present disclosure also provide an eye movement tracking control apparatus.

As illustrated in FIG. 12, the eye movement tracking control apparatus includes: an obtaining module 1210 configured to obtain the eyeball coordinate information of the two simulated eyeballs 100 and the coordinate information of the to-be-tracked target point, and determine, based on the eyeball coordinate information, the pupil distance between the two simulated eyeballs 100; a first processing module 1220 configured to determine, when the pupil distance and the target pupil distance satisfy the predetermined condition and based on the eyeball coordinate information of the two simulated eyeballs 100 and the coordinate information of the target point, the first target angle and the second target angle required for each simulated eyeball 100 to rotate to track the target point; and a second processing module 1230 configured to output the target control instruction based on the first target angle and the second target angle, control the first rotating assembly 230 to drive the simulated eyeball 100 to rotate by the first target angle, and control the second rotating assembly 240 to drive the first rotating assembly 230 and the simulated eyeball 100 to synchronously rotate by the second target angle.

According to the eye movement tracking control apparatus provided in the embodiments of the present disclosure, the pupil distance between the two simulated eyeballs 100 is kept. By obtaining the coordinate information of the target point and the eyeball coordinate information, the action of the simulated eyeball 100 gazing at the target point is decomposed into the rotation of the first rotating assembly 230 and the rotation of the second rotating assembly 240 for the motion control, achieving gazing of the simulated eyeball 100 at the target point. In this way, the motion control accuracy of the eye movement tracking is improved, and the complex eyeball movement is accurately simulated through the pitch angle rotation and the horizontal direction rotation.

In some embodiments, the second processing module 1230 is configured to:
determine, based on the eyeball coordinate information and the coordinate information of the target point, a target pitch angle required for the simulated eyeball 100 to rotate when tracking the target point; determine the first target angle of the simulated eyeball 100 based on the target pitch angle and the first angle; and determine the second target angle based on the eyeball coordinate information, the coordinate information of the target point, and the first target angle.

In some embodiments, the second processing module 1230 is configured to: determine, based on the first target angle and the motion trajectory of the pupil, the projection displacement deviation of the pupil on the horizontal plane prior to and subsequent to the rotation of the first rotating assembly 230; determine a second compensation angle based on the projection displacement deviation and the distance between the projection and the eyeball center, where the second compensation angle compensates for the angular deflection of the pupil on the horizontal plane; determine the target azimuth angle of the simulated eyeball 100 on the horizontal plane based on the coordinate information of the target point and the eyeball coordinate information; and determine the second target angle based on the second compensation angle and the target azimuth angle.

In some embodiments, the first rotating assembly 230 is driven by the first driving unit. The second rotating assembly 240 is driven by the second driving unit. The plurality of target points are provided. The second processing module 1230 is further configured to determine the target motion type and the corresponding motion control parameter, subsequent to obtaining the coordinate information of the plurality of target points. The second processing module 1230 is further configured to control, based on the target motion type, the first driving unit and the second driving unit to correspondingly drive the first rotating assembly 230 and the second rotating assembly 240 respectively in accordance with the motion control parameter.

In some embodiments, the motion control parameter includes the rotation amplitude, the speed, the acceleration, etc.

In some embodiments, the target motion type is input by the user, or the target motion type is determined based on the coordinate information of the plurality of target points.

In some embodiments, the obtaining module 1210 is configured to: obtain the image information of the target point; and determine the coordinate information of the target point based on the image information of the target point, or obtain the coordinate information of the target point input by the user.

In some embodiments, the first processing module 1220 is further configured to adjust the pupil distance between the two simulated eyeballs 100, when the pupil distance between the two simulated eyeballs 100 and the target pupil distance do not satisfy the predetermined condition, until the pupil distance between the two simulated eyeballs 100 and the target pupil distance satisfy the predetermined condition.

In the embodiments of the present disclosure, the eye movement tracking control apparatus may be an electronic device or a component in the electronic device, such as an integrated circuit or a chip. The electronic device may be a terminal, or other devices other than the terminal. Exemplarily, the electronic device may be a mobile phone, a tablet computer, a notebook computer, a palmtop computer, an in-vehicle electronic device, a Mobile Internet Device (MID), an augmented reality (AR)/virtual reality (VR) device, a robot, a wearable device, an ultra-mobile personal computer (UMPC), a netbook or a personal digital assistant (PDA), etc., or may be a server, a Network Attached Storage (NAS), a personal computer (PC), a television (TV), a teller machine or a self-service machine, etc., which is not specifically limited in the embodiments of the present disclosure.

The eye movement tracking control apparatus in the embodiments of the present disclosure may be an apparatus having an operating system. The operating system may be an Android system, an iOS system or other applicable operating systems, which is not specifically limited in the embodiments of the present disclosure.

The eye movement tracking control apparatus provided in the embodiments of the present disclosure can implement all processes realized by the method embodiments illustrated in FIG. 7 to FIG. 11. To avoid repetition, details will not be repeated herein.

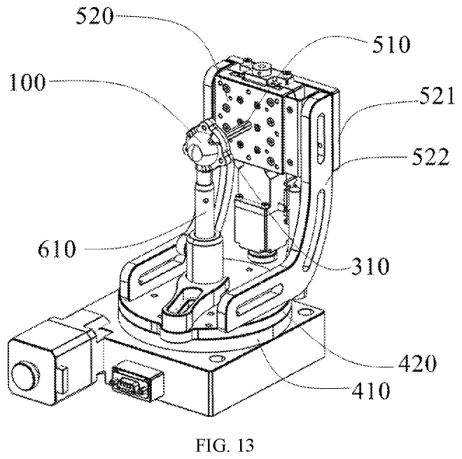

In an embodiment illustrated in FIG. 13, the simulated eyeball apparatus includes the simulated eyeball 100, the first rotating assembly, and the second rotating assembly. The first rotating assembly is connected to the simulated eyeball 100. The second rotating assembly is connected to the simulated eyeball 100. A first axis of the first rotating assembly and a second axis of the second rotating assembly intersect at a center point of the simulated eyeball 100.

The simulated eyeball 100 may be a spherical structure simulating the human eye. Each of the first rotating assembly and the second rotating assembly is connected to the simulated eyeball 100 to transmit motion and thus simulate rotation of the human eyes.

As illustrated in FIG. 15, the simulated eyeball 100 may include the spherical structure 110 and a corneo-lenticular bulge 102. The spherical structure 110 can simulate the vitreous structure of the human eye. The corneo-lenticular bulge 102 can simulate partial structures of a crystalline lens and a cornea. That is, the pupil of the simulated eyeball 100 is located at the eyeball protrusion 102.

A dimension of the simulated eyeball 100 can be adjusted based on different simulation requirements, which can simulate a dimension of a normal eyeball, or a dimension of an irregular eyeball caused by lesions or other factors.

For example, an anteroposterior diameter of the simulated eyeball 100 is 24 mm, a vertical diameter of the simulated eyeball 100 ranges from 22.6 mm to 23 mm, and a horizontal diameter of the simulated eyeball 100 ranges from 23.4 mm to 24.2 mm.

In actual implementation, materials conforming to optical properties of the human eyes can be selected to fabricate the simulated eyeball 100. The spherical structure 110 and the corneo-lenticular bulge 102 can be made of different materials, to more truly simulate the visual characteristics of the human eyes.

In this embodiment, the first rotating assembly is configured to drive the simulated eyeball 100 to rotate, with the center point of the simulated eyeball 100 serving as a circle center, in a vertical plane where the first axis is located. The second rotating assembly is configured to drive the simulated eyeball 100 to rotate about the second axis. An angle is formed between the second axis and the horizontal plane.

It should be noted that the first axis and the second axis may be virtual axes, or axes of actual rotation shafts on the first rotating assembly and the second rotating assembly.

When the first rotating assembly drives the simulated eyeball 100 to rotate, with the center point of the simulated eyeball 100 serving as the circle center, in the vertical plane where the first axis is located, except for the center point, a position of any point on the simulated eyeball 100 in the vertical direction changes.

In this embodiment, the position of the pupil in the vertical direction at the corneo-lenticular bulge 102 changes, and the pitch angle gazed by the simulated eyeball 100 changes. Through the first rotating assembly driving the simulated eyeball 100 to rotate, the pitch angle adjustment of the simulated eyeball 100 can be achieved.

It should be understood that the angle is formed between the second axis and the horizontal plane. The second axis is not an axis in the horizontal direction. The angle α between the second axis and the horizontal plane is within a range of 0°<α>90°.

The second rotating assembly drives the simulated eyeball 100 to rotate about the second axis. The second axis serves as a rotation axis of the simulated eyeball 100. Except for the point at the second axis, the position of any point on the simulated eyeball 100 in the horizontal direction changes.

In this embodiment, the position of the pupil in the horizontal direction at the corneo-lenticular bulge 102 changes, and the azimuth angle gazed by the simulated eyeball 100 changes. Through the second rotating assembly driving the simulated eyeball 100 to rotate, the azimuth angle adjustment of the simulated eyeball 100 can be achieved

In actual implementation, a rotation center of the simulated eyeball 100 may be the center point of the simulated eyeball. The first rotating assembly drives the simulated eyeball 100 to perform pitch motion, and a point on a surface of the simulated eyeball 100 moves about the center point of the simulated eyeball 100, with a motion trajectory being an arc. The second rotating assembly drives the simulated eyeball 100 to perform horizontal rotation. Through combination of the horizontal rotation and the pitch motion, the complex human eye movement can be simply and efficiently simulated.

In this embodiment, the first rotating assembly and the second rotating assembly are directly connected to the simulated eyeball 100 to achieve transmission. A parameter for controlling the simulated eyeball 100 can be directly transmitted to the first rotating assembly and the second rotating assembly, to achieve accurate motion control of the simulated eyeball 100.

For example, when a current pitch angle of the simulated eyeball 100 is 0° and needs to be adjusted upward to 30°, a corresponding control parameter is directly transmitted to the first rotating assembly, which then drives the first axis to rotate upward by 30°.

For another example, when the simulated eyeball 100 faces forward with a current azimuth angle of 0°, and the azimuth angle of the simulated eyeball 100 needs to be adjusted leftward by 20°, the corresponding control parameter is directly transmitted to the second rotating assembly, which drives rotation about the second axis by 20°.

For another example, the simulated eyeball 100 faces forward, and a current pitch angle and a current azimuth angle of the simulated eyeball 100 are both 0°. A certain tracking point in space is located obliquely in front of the simulated eyeball 100. To gaze at this tracking point, the azimuth angle of the simulated eyeball 100 needs to be adjusted leftward by 20° and the pitch angle needs to be adjusted upward by 30°. A control parameter for adjusting the two angles is transmitted to the first rotating assembly and the second rotating assembly. The first rotating assembly drives the first axis to rotate upward by 30°, and the second rotating assembly drives rotation about the second axis by 20°, achieving gazing of the simulated eyeball 100 at this tracking point.

In the related art, most test devices for simulating the human eyes adopt linkages or gears for transmission to simulate the human eye rotation. Such devices feature complicated components and low reusability, fail to directly transmit the control parameter, and are prone to measurement errors. Also, such devices have complicated motion control, can mostly only realize rotation in a single direction, and are incapable of simulating complex rotation of the human eyes simply and efficiently.

In the embodiments of the present disclosure, the first rotating assembly drives the simulated eyeball 100 to perform the pitch motion, and the second rotating assembly drives the simulated eyeball 100 to rotate, in such a manner that the first rotating assembly and the second rotating assembly are directly connected to the simulated eyeball 100 to achieve the transmission. Spatial rotation of the simulated eyeball 100 is achieved through rotation in the horizontal direction and rotation in the vertical direction. The apparatus features a simple structure and high expandability, and the control parameter can be directly transmitted to the first rotating assembly and the second rotating assembly to effectively reduce test errors. In this way, a dimension, a rotation range, and a motion mode of the real human eye can be accurately simulated. Also, when a distance from the center point of the simulated eyeball 100 to an eyeball anterior pole is maintained, irregular eyeball movement can also be simulated. In the simulated eyeball apparatus according to embodiments of the present

disclosure, the first rotating assembly and the second rotating assembly drive the simulated eyeball 100 to perform the pitch motion and the horizontal rotation, achieving a spatial rotation effect of the eyeball. With a simple structure, and the control parameter can be directly transmitted to the rotating assembly, simulating the complex rotation of the human eyes simply and efficiently.

It should be noted that the first axis and the second axis intersect at the center point of the simulated eyeball 100. When the distance from the center point of the simulated eyeball 100 to the eyeball anterior pole is determined, the rotation of the simulated eyeball 100 is not limited by a shape of the eyeball. Simulation of the normal eyeball and simulation of the irregular eyeball caused by lesions or other factors can be performed. The simulated eyeball 100 is driven by the first rotating assembly to rotate in the vertical plane where the first axis is located, and is driven by the second rotating assembly to perform horizontal rotation about the second axis.

In this embodiment, the first axis and the second axis intersect at the center point of the simulated eyeball 100. The rotation center of the simulated eyeball 100 is the center point of the simulated eyeball 100. The first rotating assembly drives the simulated eyeball 100 to rotate about the center point of the simulated eyeball 100. The second rotating assembly drives the simulated eyeball 100 to perform the horizontal rotation about the second axis passing through the center point of the simulated eyeball 100. By controlling the horizontal rotation and the pitch motion, the complex rotation of the human eyes can be simply and efficiently simulated.

In some embodiments, the simulated eyeball apparatus is configured to control, based on tracking point coordinate information of the target point, at least one of the first rotating assembly and the second rotating assembly to drive the simulated eyeball to rotate, achieving gazing of the simulated eyeball at the target point.

In this embodiment, based on the tracking point coordinate information of the target point, a control parameter required for rotation of the simulated eyeball 100 from a current position to a position for gazing at the target point is calculated. The first rotating assembly and the second rotating assembly drive the simulated eyeball 100 to rotate based on respective control parameters, achieving gazing of the simulated eyeball 100 at the target point.

For example, the current pitch angle of the simulated eyeball 100 is 0°. Based on the tracking point coordinate information of the target point, it is calculated that to direct the simulated eyeball 100 to gaze at a target gaze point, the pitch angle of the simulated eyeball 100 needs to be adjusted upward by 30°. The corresponding control parameter is directly transmitted to the first rotating assembly, which moves the simulated eyeball 100 upward by 30°. The second rotating assembly remains stationary. In this way, gazing of the simulated eyeball 100 at the target point is achieved.

For another example, the current pitch angle and the current azimuth angle of the simulated eyeball 100 are both 0°. Based on the tracking point coordinate information of the target point, it is calculated that to direct the simulated eyeball 100 to gaze at the target gaze point, the azimuth angle of the simulated eyeball 100 needs to be adjusted leftward by 20°, and the pitch angle of the simulated eyeball 100 needs to be adjusted upward by 30°. The control parameter for adjusting the two angles is transmitted to the first rotating assembly and the second rotating assembly. The first rotating assembly drives the simulated eyeball 100 to rotate upward by 30°, and the second rotating assembly drives the simulated eyeball 100 to rotate by 20°, achieving gazing of the simulated eyeball 100 at the target point.

In some embodiments, the tracking point coordinate information is input by the user.

In this embodiment, the tracking point coordinate information is input by the user. Based on the tracking point coordinate information input by the user, the rotation of the first rotating assembly and the rotation of the second rotating assembly are controlled by the simulated eyeball apparatus. In this way, gazing of the simulated eyeball 100 at the target point is achieved.

In actual implementation, user input corresponding to the tracking point coordinate information may be a touch operation, which includes but is not limited to a clicking operation, a sliding operation, and a pressing operation on the simulated eyeball apparatus or other terminal devices connected thereto. Physical key input or voice input may also be acceptable.

Of course, in other embodiments, the user input corresponding to the tracking point coordinate information may also take other forms, which includes but is not limited to character input. A specific form may be determined based on actual requirements, which is not limited in the embodiments of the present disclosure.

In some embodiments, the tracking point coordinate information is obtained by the simulated eyeball apparatus through image recognition of the target point.

In this embodiment, recognition of an image of the target point is performed by the simulated eyeball apparatus to obtain the tracking point coordinate information of the target point, and full automation of gazing of the simulated eyeball 100 at the target point can be achieved.

Detailed descriptions are given below on structures of the simulated eyeball 100, the first rotating assembly, and the second rotating assembly.

In some embodiments, the first rotating assembly includes a connection rod 510 and the first driving assembly.

The connection rod 510 serves as a transmission component. The first driving assembly is an assembly capable of outputting power to rotate the connection rod 510 in the vertical plane where the first axis is located.

In this embodiment, the connection rod 510 has an end connected to the simulated eyeball 100 at a first connection point. A line connecting the first connection point and the center point of the simulated eyeball 100 is the first axis. The first driving assembly is connected to the other end of the connection rod 510 and is configured to drive the connection rod 510 to rotate, with the center point of the simulated eyeball 100 serving as the circle center, in the vertical plane where the first axis is located.

It should be noted that the connection rod 510 is directly connected to the simulated eyeball 100. A rotation angle of the connection rod 510 in the vertical plane is directly transmitted to the simulated eyeball 100, and a same angle is rotated by the simulated eyeball 100 in the vertical plane. In this way, direct transmission of a control effect of the first rotating assembly can be effectively ensured.

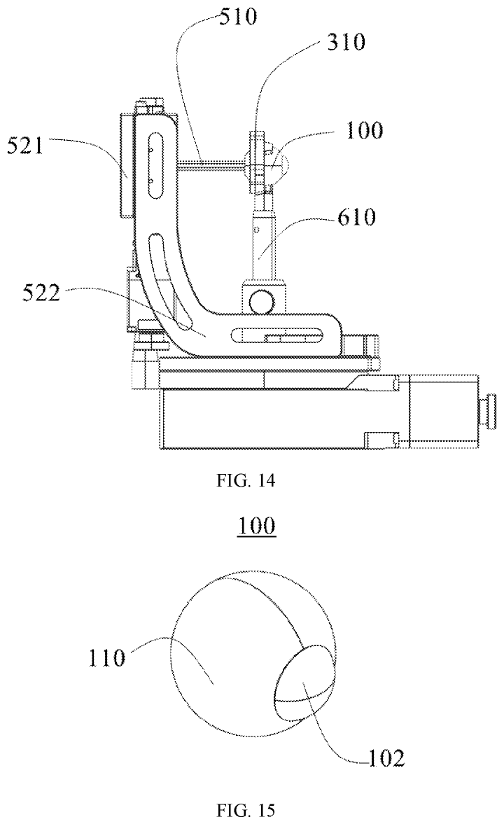

For example, as illustrated in FIG. 14, the connection rod 510 is directly connected to the simulated eyeball 100. The connection rod 510 has an end connected to the simulated eyeball 100 at the first connection point, and the other end connected to the first driving assembly. The other end of the connection rod 510 rotates upward by 30° under driving of the first driving assembly, and the simulated eyeball 100 rotates downward by 30° accordingly. In some embodiments, the first driving assembly includes a goniometric stage 520.

The goniometric stage 520, also known as a goniometer, enables components connected on the goniometric stage 520 to rotate about a fixed swing center. The goniometric stage 520 may also feature a scale to indicate a rotation angle.

In this embodiment, an output end of the goniometric stage 520 is connected to the other end of the connection rod 510. The goniometric stage 520 is configured to drive the connection rod 510 to swing, with the center point of the simulated eyeball 100 serving as the circle center, in the vertical plane where the first axis is located.

It should be noted that the connection rod 510 connected to the goniometric stage 520 cannot be extended or retracted. When the connection rod 510 is driven by the goniometric stage 520 to swing in the vertical plane where the first axis is located, a motion trajectory of the other end of the connection rod 510 is an arc, and a circle center of the arc trajectory is the center point of the simulated eyeball 100.

The center point of the simulated eyeball 100 is a swing center of the goniometric stage 520. The connection rod 510 is driven by the goniometric stage 520 to rotate upward and downward about the swing center, and the pitch angle adjustment is achieved.

It should be understood that the connection rod 510 is directly connected to the simulated eyeball 100. As the first driving assembly, the goniometric stage 520 can effectively ensure the direct transmission of the control effect of the first rotating assembly, enabling accurate control over a vertical rotation angle of the simulated eyeball 100.

In actual implementation, an appropriate goniometric stage 520 can be selected based on a vertical rotation angle range of the simulated eyeball 100.

In some embodiments, the connection rod 510 is an extendable and retractable rod having an end connected to the simulated eyeball 100. The first driving assembly includes the first driving unit.

In this embodiment, the first driving unit has an output end connected to the other end of the extendable and retractable rod. The first driving unit is configured to drive the extendable and retractable rod to rotate, with the center point of the simulated eyeball serving as the circle center, in the vertical plane where the first axis is located

It should be understood that the first driving unit may be a driving motor that provides vertical movement for the other end of the extendable and retractable rod. The other end of the extendable and retractable rod is moved in the vertical direction under driving of the first driving unit. A motion trajectory of the other end of the extendable and retractable rod is a straight line. During movement, a length of the extendable and retractable rod changes. The extendable and retractable rod rotates as a whole, with the center point of the simulated eyeball serving as the circle center, in the vertical plane where the first axis is located.

In actual implementation, the extendable and retractable rod reaches a minimum length when arranged horizontally. The length of the extendable and retractable rod is gradually extended when the other end thereof is moved upward or downward from a horizontal position under driving of the first driving unit. An extension-retraction length range of the extendable and retractable rod may be determined based on the rotation angle range of the simulated eyeball 100 in the vertical plane where the first axis is located.

In some embodiments, a rotation range of the simulated eyeball 100 in the vertical plane where the first axis is located is +45°.

In this embodiment, a goniometric stage 520 with a rotation range of +45° or other first driving assemblies may be selected, such that the simulated eyeball 100 can be driven by the first rotating assembly to rotate by a total of 90° in the vertical plane where the first axis is located, meaning that the simulated eyeball 100 can rotate upward to a position forming an angle of 45° with the horizontal plane, and the simulated eyeball 100 can rotate downward to a position forming an angle of 45° with the horizontal plane.

It should be noted that the real human eye can rotate within a total range of 135° including 60° upward and 75° downward. A comfortable angle of the human eye is 60°. The simulated eyeball 100 has a total vertical rotation range of 90°, which can ensure full coverage of a comfortable angle range.

In some embodiments, the simulated eyeball apparatus may further include a simulated eyeball fixing frame 310.

In this embodiment, the simulated eyeball fixing frame 310 is configured to fix the simulated eyeball 100. The simulated eyeball 100 is mounted in the simulated eyeball fixing frame 310. An eyeball center of the simulated eyeball fixing frame 310 coincides with the eyeball center of the simulated eyeball 100.

In actual implementation, the simulated eyeball fixing frame 310 may limit the rotation angle range of the simulated eyeball 100. For example, the simulated eyeball fixing frame 310 is configured to limit the rotation range of the simulated eyeball 100 in the vertical plane where the first axis is located to +45°.

In actual implementation, an inner surface of the simulated eyeball fixing frame 310 matches an outer surface of the simulated eyeball 100 in shape. The inner surface of the simulated eyeball fixing frame 310 and the outer surface of the simulated eyeball 100 have a same spherical structure, in such a manner that the eyeball center of the simulated eyeball fixing frame 310 can be ensured to coincide with the eyeball center of the simulated eyeball 100, subsequent to placing the simulated eyeball 100 into the simulated eyeball fixing frame 310.

The simulated eyeball fixing frame 310 not only ensures that the simulated eyeball 100 can rotate freely up and down, but also limits an eyeball rotation range through a boundary of the simulated eyeball mounting frame 310, to meet different rotation range requirements of the simulated eyeball 100.

In some embodiments, the simulated eyeball fixing frame 310 is provided with a limit structure 320 facing the gaze direction of the simulated eyeball 100. The limit structure 320 abuts against the simulated eyeball 100 when the simulated eyeball 100 is at a maximum rotation angle.

As illustrated in FIG. 17, the simulated eyeball fixing frame 310 is provided with the limit structure 320 facing the gaze direction of the simulated eyeball 100. When the simulated eyeball 100 is at the maximum rotation angle, that is, when the simulated eyeball 100 rotates upward by 45° or downward by 45°, the limit structure 320 abuts against the simulated eyeball 100, and the rotation range of the simulated eyeball 100 is limited.

In actual implementation, a plurality of limit structures 320 may be disposed in a circumferential direction of the simulated eyeball fixing frame 310.

In some embodiments, the simulated eyeball fixing frame 310 may also be provided with the limit structure 320 facing away from the gaze direction of the simulate eyeball 100. The limit structure 320 abuts against the simulated eyeball 100 when the simulated eyeball 100 is at the maximum rotation angle.

In this embodiment, the simulated eyeball fixing frame 310 is provided with the limit structure 320 facing away from the gaze direction of the simulated eyeball 100. When the simulated eyeball 100 is at the maximum rotation angle, the simulated eyeball 100 or the connection rod 510 interferes with the limit structure 320, and the limit structure 320 abuts against the simulated eyeball 100 to limit the rotation range of the simulated eyeball 100.

In some embodiments, the simulated eyeball fixing frame 310 includes a first fixing frame body 311 and a second fixing frame body 312. A flange of the second fixing frame body 312 is nested inside the first fixing frame body 311. The limit structure 320 is disposed at an edge of the first fixing frame body 311.

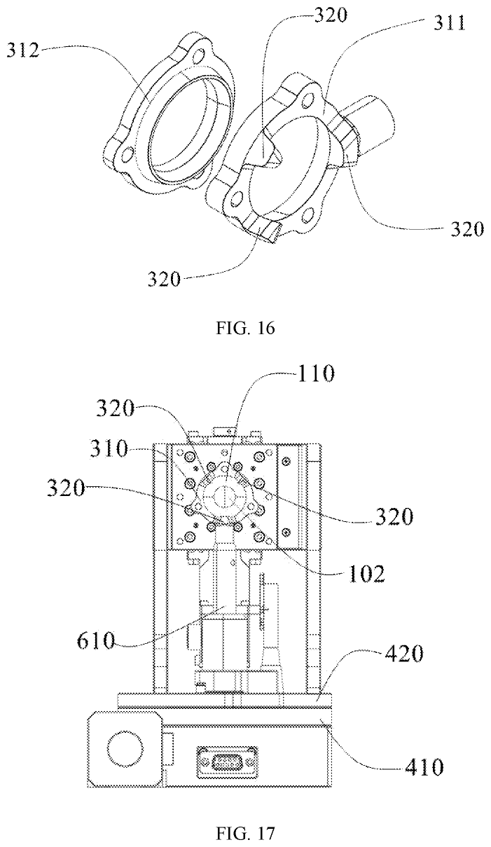

As illustrated in FIG. 16, the second fixing frame body 312 has a flange at a side facing towards the first fixing frame body 311. The flange of the second fixing frame body 312 is nested inside the first fixing frame body 311. When the first fixing frame 311 and the second fixing frame 312 are assembled together, their inner surfaces have the same spherical structure as the outer surface of the simulated eyeball 100.

The first fixing frame body 311 is a frame body that simulates the gaze direction of the simulated eyeball 100. The limit structure 320 is disposed at the edge of the first fixing frame body 311.

In some embodiments, the simulated eyeball fixing frame 310 may include two or more fixing frame bodies, which are connected to form the simulated eyeball fixing frame 310.

For example, the simulated eyeball fixing frame 310 includes two fixing frame bodies constructed as an up-down structure. The two fixing frame bodies are connected together by a connection assembly, such as a screw, a bolt, etc.

In some embodiments, a rotation range of the simulated eyeball 100 about the second axis is 360°.

In this embodiment, the simulated eyeball 100 can rotate through a full 360° range about the second axis. The second rotating assembly capable of 360° rotation may be selected.

It should be noted that, a horizontal rotation range of a single real human eye is 95° outward (away from the other eye) and 60° inward (towards the other eye). An overlapping visual field angle of both eyes is 120°, and the comfortable angle is 60°.

In this embodiment, the simulated eyeball 100 can rotate through a full 360° range about the second axis, ensuring full coverage of the left and right eye movement ranges, and simplifying a structure of the second rotating assembly without a need for other limit devices.

In some embodiments, the second rotating assembly includes a rotary stage 410.

In this embodiment, the simulated eyeball 100 is disposed at the rotary stage 410. A rotation center of the rotary stage 410 coincides with the center point of the simulated eyeball 100. A rotation range of the rotary stage 410 is 360°.

In actual implementation, an optical rotary stage 410 may be used to ensure rotation accuracy.

In some embodiments, the simulated eyeball apparatus may further include a first lifting structure.

In this embodiment, the first rotating assembly is mounted to the first lifting structure. The first lifting structure is configured to drive the first rotating assembly to lift and lower.

In actual implementation, a vertical height of the first rotating assembly may be adjusted based on different test eyeballs.

For example, the first rotating assembly includes the connection rod 510 and the goniometric stage 520. The first lifting structure is a goniometric stage lifting connection plate 522. The goniometric stage 520 is fixed to the goniometric stage lifting connection plate 522 through a goniometric stage fixing plate 521. The goniometric stage lifting connection plate 522 can realize lifting adjustment through structures such as gears, racks or threads.

It should be understood that, the first rotating assembly is connected to the simulated eyeball 100. When a height of the first rotating assembly is adjusted by the first lifting structure, the height of the simulated eyeball 100 is adjusted accordingly.

In some embodiments, the simulated eyeball apparatus may further include a second support 610.

In this embodiment, the simulated eyeball 100 is mounted to the second support 610. The second support 610 is a liftable support.

The second support 610 is configured to support the simulated eyeball 100 and is the liftable support. The height of the simulated eyeball 100 can be adjusted synchronously when the height of the first rotating assembly is adjusted by the first lifting structure.

In actual implementation, the second support 610 may be an extension and retraction rod, a sleeve, or other structures.

In some embodiments, the simulated eyeball apparatus may further include an assembly connection structure.

In this embodiment, the assembly connection structure is connected to the second rotating assembly. The first rotating assembly is mounted to the assembly connection structure. The assembly connection structure is a structure that connects the first rotating

assembly and the second rotating assembly. When the second rotating assembly drives the simulated eyeball 100 to rotate about the second axis, the assembly connection structure enables the first rotating assembly to rotate synchronously about the second axis.

For example, the assembly connection structure is a rotary stage connection plate 420. The rotary stage connection plate 420 is connected to an upper end of the rotary stage. The goniometric stage 520 is fixed to the goniometric stage lifting connection plate 522 through the goniometric stage fixing plate 521. The goniometric stage lifting connection plate 522 is mounted at the rotary stage connection plate 420. When the rotary stage 410 rotates, the rotary stage connection plate 420 drives the simulated eyeball 100, the goniometric stage 520, the goniometric stage fixing plate 521, and the goniometric stage lifting connection plate 522 to rotate together.

In some embodiments illustrated in FIG. 13, the simulated eyeball 100 is placed in the simulated eyeball fixing frame 310. The simulated eyeball 100 is directly connected to an end of the connection rod 510, and the other end of the connection rod 510 is connected to the goniometric stage 520. The goniometric stage 520 drives the simulated eyeball 100 to perform an up-and-down swing motion, with the center point of the simulated eyeball 100 serving as the circle center.

The goniometric stage fixing plate 521 is configured to fix the goniometric stage 520, and is connected to the goniometric stage lifting connection plate 522. The goniometric stage lifting connection plate 522 is connected to the goniometric stage 520 and the rotary stage connection plate 420 for lifting adjustment.

The rotary stage 410 provides rotation motion. The rotation center coincides with the center point of the simulated eyeball 100. The second support 610 of the simulated eyeball 100 is mounted to the rotary stage connection plate 420 and drives the simulated eyeball 100 to rotate. The rotary stage connection plate 420 is further connected to the goniometric stage lifting connection plate 522 and drives the goniometric stage 520 to rotate together.

In this embodiment, the rotary stage 410 drives the simulated eyeball 100 to rotate horizontally, the goniometric stage 520 drives the simulated eyeball 100 to perform up-down swing, and the simulated eyeball 100 moves in a three-dimensional space, in such a manner that a real rotation effect of the human eyes is realized, and 360° horizontal rotation and total 90° up-down arc movement can be realized. With a simple structure, the control parameter can be directly transmitted to the rotating assembly, simulating the complex rotation of the human eyes simply and efficiently.

Movement modes that can be simulated by the simulated eyeball apparatus are introduced in detail below.

In some embodiments, movement modes of the simulated eyeball 100 include at least one of up-down movement, left-right movement, smooth multi-line scanning, saccade, gaze with micro-movement, convergence approaching, and convergence departing.

In an up-down movement mode, the first rotating assembly drives the simulated eyeball 100 to rotate within a certain angle range, with the center point of the simulated eyeball 100 serving as the circle center, in the vertical plane where the first axis is located. In a left-right movement mode, the second rotating assembly drives the simulated eyeball 100 to rotate within a certain angle range about the second axis.

In a smooth multi-line scanning movement mode, the second rotating assembly may drive the simulated eyeball 100 to rotate at a constant speed within a certain angle range about the second axis. Upon completion of each line, the first rotating assembly drives the simulated eyeball 100 to rotate within a certain angle range, with the center point of the simulated eyeball 100 serving as the circle center, in the vertical plane where the first axis is located, to switch to a next line.

In a saccade movement mode, the simulated eyeball 100 can be driven to rotate at any angles by the first rotating assembly and the second rotating assembly.

In the movement mode of gaze with micro-movement, the simulated eyeball 100 can be driven to rotate at any angles by the first rotating assembly and the second rotating assembly. After the simulated eyeball 100 gazes at a certain point, the first rotating assembly and the second rotating assembly drive the simulated eyeball 100 to move slightly.

It should be understood that the two movement modes of convergence approaching and convergence departing can be achieved by providing two simulated eyeball apparatus.

In a convergence approaching movement mode, the simulated eyeballs 100 of the two apparatus rotate inward, and the second rotating assembly drives the simulated eyeball 100 to rotate within a certain angle range about the second axis.

In a convergence departing movement mode, the simulated eyeballs 100 of the two apparatus rotate outward, and the second rotating assembly drives the simulated eyeball 100 to rotate within a certain angle range about the second axis.

In the simulated eyeball apparatus according to the embodiments of the present disclosure, the simulated eyeball 100 is driven to rotate in the horizontal direction and the vertical direction by the first rotating assembly and the second rotating assembly to achieve the spatial rotation effect of the eyeball. In this way, complex rotation of different types of human eyes can be simulated simply and efficiently.

The embodiments of the present disclosure further provide an eye movement tracking method.

The eye movement tracking method can be applied to the above simulated eyeball apparatus. The first rotating assembly and the second rotating assembly are controlled to drive the simulated eyeball 100 to perform the pitch motion and the horizontal rotation, to achieve the spatial rotation effect of the eyeball. In this way, the complex rotation of the human eyes can be simply and efficiently simulated.

The embodiments of the present disclosure provide the eye movement tracking method. An executor of the eye movement tracking method may be an electronic device, or a function module or a function entity capable of implementing the eye movement tracking method in the electronic device. The electronic device mentioned in the embodiments of the present disclosure includes but is not limited to a mobile phone, a tablet computer, a computer, a camera, a wearable device or the like. The eye movement tracking method provided in the embodiments of the present disclosure is described below by taking the electronic device as the executor.

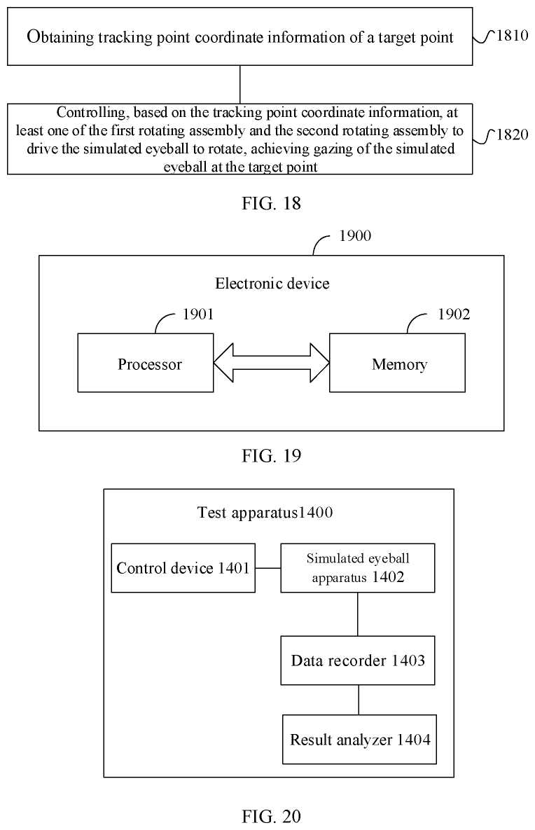

As illustrated in FIG. 18, the eye movement tracking method includes block 1810 and block 1820.

At block 1810, the tracking point coordinate information of the target point is obtained.

The target point refers to a point to be tracked and gazed at by the simulated eyeball apparatus.

In this operation, the tracking point coordinate information of the target point is obtained. A coordinate system can be established based on any point on the simulated eyeball apparatus to obtain the tracking point coordinate information. Alternatively, a coordinate system is established at any point in space to obtain the tracking point coordinate information.

It should be understood that, obtaining of the tracking point coordinate information of the target point is intended to calculate a position difference between the simulated eyeball 100 and the target point. In this operation, the coordinate information of the simulated eyeball 100 can be obtained simultaneously to calculate the position difference between the simulated eyeball 100 and the target point.

In actual implementation, a coordinate system can be established with the center point of the simulated eye 100 serving as the origin. The coordinate information of the simulated eyeball 100 serves as origin coordinate information. Subsequently, the tracking point coordinate information of the target point is obtained.

At block 1820, based on the tracking point coordinate information, at least one of the first rotating assembly and the second rotating assembly is controlled to drive the simulated eyeball 100 to rotate, achieving gazing of the simulated eyeball 100 at the target point.

In this embodiment, based on the tracking point coordinate information of the target information, the control parameter required for the rotation of the simulated eyeball 100 from the current position to the position for gazing at the target point is calculated. The first rotating assembly and the second rotating assembly drive the simulated eyeball 100 to rotate based on respective control parameters, achieving gazing of the simulated eyeball 100 at the target point.

For example, the current pitch angle of the simulated eyeball 100 is 0°. Based on the tracking point coordinate information of the target point, it is calculated that to direct the simulated eyeball 100 to gaze at the target gaze point, the pitch angle of the simulated eyeball 100 needs to be adjusted upward by 30°. The corresponding control parameter is directly transmitted to the first rotating assembly, which moves the simulated eyeball 100 upward by 30°. The second rotating assembly remains stationary. In this way, gazing of the simulated eyeball 100 at the target point is achieved.

For another example, the current pitch angle and the current azimuth angle of the simulated eyeball 100 are both 0°. Based on the tracking point coordinate information of the target point, it is calculated that to direct the simulated eyeball 100 to gaze at the target gaze point, the azimuth angle of the simulated eyeball 100 needs to be adjusted leftward by 20°, and the pitch angle of the simulated eyeball 100 needs to be adjusted upward by 30°. The control parameter for adjusting the two angles is transmitted to the first rotating assembly and the second rotating assembly. The first rotating assembly drives the simulated eyeball 100 to tilt upward by 30°, and the second rotating assembly drives the simulated eyeball 100 to rotate by 20°, achieving gazing of the simulated eyeball 100 at the target point.

According to the eye movement tracking method provided in the embodiments of the present disclosure, by obtaining the tracking point coordinate information of the target point, and by controlling the first rotating assembly and the second rotating assembly to drive the simulated eyeball 100 to perform the pitch motion and the horizontal rotation, the spatial rotation effect of the eyeball can be achieved. With a simple structure, the control parameter can be directly transmitted to the rotating assembly, simulating the complex rotation of the human eyes simply and efficiently.

In some embodiments, block 1810 of obtaining the tracking point coordinate information of the target point may include: obtaining the tracking point coordinate information input by the user.

In this embodiment, the tracking point coordinate information is input by the user. Based on the tracking point coordinate information input by the user, the rotation of the first rotating assembly and the rotation of the second rotating assembly are controlled to achieve gazing of the simulated eyeball 100 at the target point.

In actual implementation, user input corresponding to the tracking point coordinate information may be a touch operation, which includes but is not limited to a clicking operation, a sliding operation, and a pressing operation on the simulated eyeball apparatus or other terminal devices connected thereto. Physical key input or voice input may also be acceptable.

Of course, in other embodiments, the user input corresponding to the tracking point coordinate information may also take other forms, which includes but is not limited to character input. A specific form may be determined based on actual requirements, which is not limited in the embodiments of the present disclosure.

In some embodiments, block 1810 of obtaining the tracking point coordinate information of the target point may include: obtaining the image of the target point and performing image recognition to obtain the tracking point coordinate information.

In this embodiment, recognition is performed based on the image of the target point to obtain the tracking point coordinate information of the target point, and full automation of gazing of the simulated eyeball 100 at the target point can be achieved.

In some embodiments, block 1820 of controlling, based on the tracking point coordinate information, at least one of the first rotating assembly and the second rotating assembly to drive the simulated eyeball 100 to rotate may include: controlling, based on the tracking point coordinate information, at least one of the first rotating assembly and the second rotating assembly to drive the simulated eyeball 100 to rotate in accordance with a target movement mode.

The target movement mode is one of the movement modes that the simulated eyeball 100 can achieve. The movement modes of the simulated eyeball 100 include at least one of up-down movement, left-right movement, smooth multi-line scanning, saccade, gaze with micro-movement, convergence approaching, and convergence departing.

In some embodiments, as illustrated in FIG. 19, the embodiments of the present disclosure further provide an electronic device 1990. The electronic device 1990 includes a processor 1901, a memory 1902, and a computer program stored in the memory 1902 and executable by the processor 1901. The computer program, when executed by the processor 1901, implements each process of the embodiments of the above eye movement tracking method or the eye movement tracking control method. The same technical effects can be achieved. To avoid repetition, detailed descriptions are omitted herein.

It should be noted that, the electronic device in the embodiments of the present disclosure includes the above mobile electronic device and non-mobile electronic device.

The embodiments of the present disclosure further provide a non-transitory computer-readable storage medium. The non-transitory computer-readable storage medium has a computer program stored thereon. The computer program, when executed by a processor, implements each process of the embodiments of the above eye movement tracking method or the eye movement tracking control method. The same technical effects can be achieved. To avoid repetition, detailed descriptions are omitted herein.

The processor is a processor in the electronic device described in the above embodiments. The readable storage medium includes a computer-readable storage medium, such as a computer read-only memory ROM, a random access memory RAM, a magnetic disk, or a CD, etc.

The embodiments of the present disclosure further provide a computer program product. The computer program product includes a computer program. The computer program, when executed by a processor, implements the above eye movement tracking method or the eye movement tracking control method.

The processor is the processor in the electronic device described in the above embodiments. The readable storage medium includes the computer-readable storage medium, such as the computer read-only memory ROM, the random access memory RAM, the magnetic disk, or the CD, etc.

The embodiments of the present disclosure further provide a chip. The chip includes a processer and a communication interface coupled to the processor. The processor is configured to execute a program or instructions to implement each process of the embodiments of the above eye movement tracking method or the eye movement tracking control method. The same effects can be achieved. To avoid repetition, detailed descriptions are omitted herein.

It should be understood that, the chip mentioned in the embodiments of the present disclosure may also be called a system-level chip, a system chip, a chip system, or an on-chip system chip, etc.

The embodiments of the present disclosure further provide a test apparatus 1400.

As illustrated in FIG. 20, the test apparatus 1400 includes the above simulated eyeball apparatus 1402, a control device 1401, a data recorder 1403, and a result analyzer 1401.

The control device 1401 is connected to the simulated eyeball apparatus 1402 and configured to control movement of the simulated eyeball 100 to test a device under test. The device under test is an instrument for recording and analyzing the human eye

movement, which can determine information such as a gazing position and duration of the human eyes by measuring a position, a speed, and an acceleration of the eyeball.

In this embodiment, the simulated eyeball apparatus 1402 is used to replace the real human eyes. The device under test records movement data of the simulated eyeball 100 in the simulated eyeball apparatus 1402. Based on these movement data, parameters such as sensitivity, discreteness, and stability of the device under test are determined.

The control device 1401 can define parameters such as the speed, the acceleration, a path, and a movement amplitude of the simulated eyeball 100, transmit instructions to the various driving units of the simulated eyeball apparatus 1402, and control the simulated eyeball 100 to perform actions such as the pitch angle rotation, the horizontal rotation, the pupil distance adjustment, and the height adjustment, accurately simulating the multi-dimensional complex movement of the human eyes.

In actual implementation, the control device 1401 may be connected to the motion controller of the simulated eyeball apparatus 1402. The control device 1401 outputs an instruction signal to the motion controller, which further transmits an instruction to the driving units including the first driving unit and the second driving unit. In this way, the simulated eyeball 100 is controlled to achieve the actions such as the pitch angle rotation, the horizontal direction rotation, the pupil distance adjustment, and the height adjustment.

In this embodiment, the data recorder 1403 of the test apparatus 1400 is connected to the simulated eyeball apparatus 1402. The data recorder 1403 includes a data collecting unit and a test-device interfacing unit.

The data collecting unit is configured to collect eyeball movement data of the simulated eyeball 100. The test-device interfacing unit is connected to the device under test and configured to collect eyeball movement data recorded by the device under test.

The data collecting unit is configured to directly collect the movement data of the simulated eyeball 100. The test-device interfacing unit is connected to the device under test to record the movement data of the simulated eyeball 100 collected by the device under test. Parameters such as sensitivity, discreteness, and stability of the device under test are tested through the two sets of movement data.

The result analyzer 1404 is connected to the data collecting unit and the test-device interfacing unit, and is configured to test accuracy of the device under test based on the eyeball movement data of the simulated eyeball 100 and the eyeball movement data recorded by the device under test.

Testing the accuracy of the device under test refers to testing accuracy and precision of eye movement tracking performed by the device under test.

In some embodiments, the test device 1401 includes a parameter definition module and a motion control module.

The parameter definition module is connected to the motion control module, and is configured to input an eyeball movement parameter of the simulated eyeball 100 to determine eyeball movement data of the simulated eyeball 100. The motion control module is connected to both the parameter definition module and the simulated eyeball apparatus 1402, and is configured to output the eyeball movement parameter to the simulated eyeball apparatus 1402 to control the movement of the simulated eyeball 100.

In this embodiment, the user inputs different eyeball movement parameters in the parameter definition module to control the movement of the simulated eyeball 100.

In some embodiments, the eyeball movement data of the simulated eyeball 100 is analyzed and obtained by the control device 1401 based on position information of the to-be-tracked target point and position information of the simulated eyeball 100.

In this embodiment, the control device 1401 can control the simulated eyeball 100 to autonomously track the target point without manually inputting a relevant parameter of the target point.

A test process of the test apparatus 1400 is described in detail below.

Operation 1: Defining a test parameter.

Prior to the test, a type and a parameter of eye rotation are defined in the parameter definition module of the control device 1401, including a start angle, an end angle, a movement speed, an acceleration, acceleration time, a deceleration, deceleration time, a motion trajectory, and other parameters, for subsequent motion control and data recording of the simulated eyeball apparatus 1402.

Operation 2: Motion control.

The motion control module of the control device 1401 controls a driving unit of the simulated eyeball apparatus 1402 to realize control and recording of the eyeball movement of the simulated eyeball apparatus 1402.

Operation 3: Recording data.

The data collecting unit of the data recorder 1403 directly records parameters including the motion trajectory, the speed, and the acceleration of the simulated eyeball 100.

The test-device interfacing unit records the movement data of the simulated eyeball 100 connected by the device under test for subsequent data analysis and result comparison.

Step 4: Analyzing test results.

By comparing and analyzing an actual movement parameter of the simulated eyeball apparatus 1402 with the movement parameter collected by the device under test, a series of parameters including accuracy, precision, and discreteness of the device under test are evaluated.

Compared with a conventional test method (real human eye test), the test apparatus 1400 in the embodiments of the present disclosure can measure multiple parameters such as rotation in different directions, the speed, and the acceleration of the eyes, testing the device under test more comprehensively. The simulated eyeball 100 of the simulated eyeball apparatus 1402 features higher rotation accuracy and better stability. The control device 1401 enables accurate and reliable data recording and analysis, achieving automated test procedures. Thus, while improving test efficiency, the accuracy is higher.

According to the test apparatus 1400 provided in the embodiments of the present disclosure, the device under test is tested by means of the simulated eyeball apparatus 1402, which can accurately simulate the multi-dimensional complex movement of the human eyes and improve accuracy of an eye movement test.

In the description of the present disclosure, it should be understood that the orientation or the position indicated by terms such as “center”, “length”, “width”, “over”, “below”, “front”, “rear”, “left”, “right”, “vertical”, “horizontal”, “top”, “bottom”, “inner”, “outer”, “axial”, and “circumferential” should be construed to refer to the orientation or the position as shown in the drawings, and is only for the convenience of describing the present disclosure and simplifying the description, rather than indicating or implying that the pointed apparatus or element must have a specific orientation, or be constructed and operated in a specific orientation, and therefore cannot be understood as a limitation to the present disclosure.

In the description of the present disclosure, the “first feature” and the “second feature” may include one or more of these features.

In the description of the present disclosure, “plurality” means at least two.

In the description of the present disclosure, the first feature “on” or “under” the second feature may mean that the first feature is in direct contact with the second feature, or the first and second features are in indirect contact through another feature between them.

In the description of the present disclosure, the first feature “above” the second feature means that the first feature is directly above or obliquely above the second feature, or simply means that the level of the first feature is higher than that of the second feature.

In the description of the present disclosure, reference throughout this specification to “an embodiment”, “some embodiments”, “an illustrative embodiment”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims and their equivalents.

What is claimed is:

1. A simulated eyeball apparatus, comprising:
a simulated eyeball;
a first rotating assembly connected to the simulated eyeball; and
a second rotating assembly connected to the simulated eyeball and the first rotating assembly,
wherein a rotation axis of the first rotating assembly and a rotation axis of the second rotating assembly are non-parallel and lie in two non-parallel planes, to ensure that, through cooperation of the first rotating assembly and the second rotating assembly, when the simulated eyeball apparatus tracks a target point, based on position information of the simulated eyeball and position information of the target point, the first rotating assembly drives the simulated eyeball to rotate to adjust a pitch angle of the simulated eyeball, and the second rotating assembly drives the simulated eyeball and the first rotating assembly to rotate synchronously to adjust a horizontal azimuth angle of the simulated eyeball, achieving three-dimensional spatial rotation of the simulated eyeball driven by the two axes.

2. The simulated eyeball apparatus according to claim 1, wherein an axial extension line of the first rotating assembly and an axial extension line of the second rotating assembly intersect at an eyeball center of the simulated eyeball.

3. The simulated eyeball apparatus according to claim 1, wherein a first angle is formed between a line connecting a pupil and the eyeball center of the simulated eyeball and an axial direction of the first rotating assembly, to ensure that, through cooperation of the first rotating assembly, the second rotating assembly, and the first angle, when the simulated eyeball apparatus tracks the target point, based on the position information of the simulated eyeball and the position information of the target point, the first rotating assembly drives the simulated eyeball to rotate to adjust the pitch angle of the simulated eyeball, and the second rotating assembly drives the simulated eyeball and the first rotating assembly to rotate synchronously to adjust the horizontal azimuth angle of the simulated eyeball, achieving the three-dimensional spatial rotation of the simulated eyeball driven by the two axes.

4. The simulated eyeball apparatus according to claim 3, wherein:
two simulated eyeballs are provided; and
when the two simulated eyeballs are at an initial position, a second angle is formed between rotation axes of the two first rotating assemblies.

5. The simulated eyeball apparatus according to claim 3, wherein:
two simulated eyeballs are provided; and
the simulated eyeball apparatus further comprises a third driving assembly for adjusting a pupil distance between the two simulated eyeballs.

6. The simulated eyeball apparatus according to claim 5, wherein a maximum rotation angle of the second rotating assembly is determined based on the pupil distance between the two simulated eyeballs.

7. The simulated eyeball apparatus according to claim 6, wherein a maximum rotation angle of the first rotating assembly is 360°, and the maximum rotation angle of the second rotating assembly is less than 360°.

8. The simulated eyeball apparatus according to claim 5, further comprising an eyeball base at which the simulated eyeball is located,
wherein the first rotating assembly is connected to the simulated eyeball via the eyeball base, the second rotating assembly is connected to the first rotating assembly and the simulated eyeball via the eyeball base, and the second rotating assembly drives the first rotating assembly and the simulated eyeball to rotate synchronously; and
wherein the third driving assembly is correspondingly connected to two eyeball bases and drives the two eyeball bases to move towards or away from each other, to adjust the pupil distance between the two simulated eyeballs.

9. The simulated eyeball apparatus according to claim 8, wherein the third driving assembly comprises a third driving unit and a linear sliding table connected to the third driving unit, wherein the two eyeball bases are disposed at the linear sliding table,
or,
wherein the simulated eyeball apparatus further comprises a fourth driving assembly connected to the eyeball base, wherein the fourth driving assembly drives the eyeball base to move in an axial direction of the second rotating assembly to adjust a height of the simulated eyeball.

10. The simulated eyeball apparatus according to claim 3, further comprising:
a first support comprising a first fixing plate and a second fixing plate perpendicular to the first fixing plate,
wherein the other end of the first rotating assembly passes through a mounting hole of the first fixing plate and is connected to the simulated eyeball; and
wherein the other end of the second rotating assembly is connected to the second fixing plate.

11. The simulated eyeball apparatus according to claim 1, wherein:
the first rotating assembly is connected to the simulated eyeball, and is configured to drive the simulated eyeball to rotate, with a center point of the simulated eyeball serving as a circle center, in a vertical plane where a first axis is located; and
the second rotating assembly is connected to the simulated eyeball, and is configured to drive the simulated eyeball to rotate about a second axis, an angle being formed between the second axis and a horizontal plane.

12. The simulated eyeball apparatus according to claim 11, further comprising a simulated eyeball fixing frame,
wherein the simulated eyeball is mounted inside the simulated eyeball fixing frame; and
wherein a structural center of the simulated eyeball fixing frame coincides with the center point of the simulated eyeball.

13. The simulated eyeball apparatus according to claim 12, wherein the simulated eyeball fixing frame is configured to limit a rotation range of the simulated eyeball in the vertical plane where the first axis is located to ±45°.

14. The simulated eyeball apparatus according to claim 13, wherein the simulated eyeball fixing frame is provided with a limit structure in a gaze direction of the simulated eyeball, and wherein the limit structure abuts against the simulated eyeball when the simulated eyeball is at a maximum rotation angle.

15. The simulated eyeball apparatus according to claim 14, wherein the simulated eyeball fixing frame comprises:
a first fixing frame body; and
a second fixing frame body,
wherein a flange of the second fixing frame body is nested inside the first fixing frame body, and
wherein the limit structure is disposed at an edge of the first fixing frame body.

16. The simulated eyeball apparatus according to claim 11, wherein the first rotating assembly comprises:
a connection rod having an end connected to the simulated eyeball at a first connection point, a line connecting the first connection point and the center point of the simulated eyeball being the first axis; and
a first driving assembly connected to the other end of the connection rod and configured to drive the connection rod to rotate, with the center point of the simulated eyeball serving as the circle center, in the vertical plane where the first axis is located.

17. The simulated eyeball apparatus according to claim 16, wherein the first driving assembly comprises a goniometric stage, wherein:
an output end of the goniometric stage is connected to the other end of the connection rod;
the goniometric stage is configured to drive the connection rod to swing, with the center point of the simulated eyeball serving as the circle center, in the vertical plane where the first axis is located; and
a motion trajectory of the other end of the connection rod is an arc,
or,
wherein:
the connection rod is an extendable and retractable rod having an end connected to the simulated eyeball; and
the first driving assembly comprises a first driving unit having an output end connected to the other end of the extendable and retractable rod, the first driving unit being configured to drive the extendable and retractable rod to rotate, with the center point of the simulated eyeball serving as the circle center, in the vertical plane where the first axis is located; and
a motion trajectory of the other end of the extendable and retractable rod is a straight line.

18. The simulate eyeball apparatus according to claim 11, wherein a rotation range of the simulated eyeball in the vertical plane where the first axis is located is ±45°,
or wherein a rotation range of the simulated eyeball about the second axis is 360°,
or wherein the simulate eyeball apparatus further comprises a first lifting structure,
wherein:
the first rotating assembly is mounted to the first lifting structure; and
the first lifting structure is configured to drive the first rotating assembly to lift and lower,
or wherein the simulate eyeball apparatus further comprises a second support, wherein:
the simulated eyeball is mounted to the second support; and
the second support is a liftable support,
or wherein movement modes of the simulated eyeball comprise at least one of up-down movement, left-right movement, smooth multi-line scanning, saccade, gaze with micro-movement, convergence approaching, and convergence departing.

19. A test apparatus, comprising:
a simulated eyeball apparatus;
a control device connected to the simulated eyeball apparatus and configured to control movement of a simulated eyeball to test a device under test;
a data recorder connected to the simulated eyeball apparatus and comprising a data collecting unit and a test-device interfacing unit, wherein the data collecting unit is configured to collect eyeball movement data of the simulated eyeball, and wherein the test-device interfacing unit is connected to the device under test and configured to collect eyeball movement data recorded by the device under test; and
a result analyzer connected to the data collecting unit and the test-device interfacing unit, and configured to test accuracy of the device under test based on the eyeball movement data of the simulated eyeball and the eyeball movement data recorded by the device under test,
wherein the simulated eyeball apparatus comprises:
the simulated eyeball;
a first rotating assembly connected to the simulated eyeball; and
a second rotating assembly connected to the simulated eyeball and the first rotating assembly,
wherein a rotation axis of the first rotating assembly and a rotation axis of the second rotating assembly are non-parallel and lie in two non-parallel planes, to ensure that, through cooperation of the first rotating assembly and the second rotating assembly, when the simulated eyeball apparatus tracks a target point, based on position information of the simulated eyeball and position information of the target point, the first rotating assembly drives the simulated eyeball to rotate to adjust a pitch angle of the simulated eyeball, and the second rotating assembly drives the simulated eyeball and the first rotating assembly to rotate synchronously to adjust a horizontal azimuth angle of the simulated eyeball, achieving three-dimensional spatial rotation of the simulated eyeball driven by the two axes.

20. An eye movement tracking method applied to a simulated eyeball apparatus, the method comprising:
obtaining tracking point coordinate information of a target point; and
controlling, based on the tracking point coordinate information, at least one of a first rotating assembly and a second rotating assembly to drive a simulated eyeball to rotate, achieving gazing of a simulated eyeball at the target point,
wherein the simulated eyeball apparatus comprises:
the simulated eyeball;
the first rotating assembly connected to the simulated eyeball; and
the second rotating assembly connected to the simulated eyeball and the first rotating assembly,
wherein a rotation axis of the first rotating assembly and a rotation axis of the second rotating assembly are non-parallel and lie in two non-parallel planes, to ensure that, through cooperation of the first rotating assembly and the second rotating assembly, when the simulated eyeball apparatus tracks the target point, based on position information of the simulated eyeball and position information of the target point, the first rotating assembly drives the simulated eyeball to rotate to adjust a pitch angle of the simulated eyeball, and the second rotating assembly drives the simulated eyeball and the first rotating assembly to rotate synchronously to adjust a horizontal azimuth angle of the simulated eyeball, achieving three-dimensional spatial rotation of the simulated eyeball driven by the two axes.
